(19) United States
(12) Patent Application Publication
(10) Pub. No.: US 2014/0154440 A1
(43) Pub. Date: Jun. 5, 2014

(54) GLASS FOR CHEMICAL STRENGTHENING AND GLASS HOUSING

(71) Applicant: ASAHI GLASS COMPANY, LIMITED, Chiyoda-ku (JP)

(72) Inventors: Yuuichi Iida, Haibara-gun (JP); Makoto Shiratori, Haibara-gun (JP)

(73) Assignee: ASAHI GLASS COMPANY, LIMITED, Chiyoda-ku (JP)

(21) Appl. No.: 14/176,451

(22) Filed: Feb. 10, 2014

Related U.S. Application Data
(63) Continuation of application No. PCT/JP2012/070014, filed on Aug. 6, 2012.

(30) Foreign Application Priority Data
Aug. 10, 2011 (JP) 2011-175421
Aug. 17, 2011 (JP) 2011-178526

(51) Int. Cl. C03C 14/00

(52) U.S. Cl. CPC C03C 14/008
USPC 428/34.4; 501/32

(57) ABSTRACT

To provide glass for chemical strengthening from which glass having high strength and having excellent solarization resistance is obtained, and a housing such glass. Glass for chemical strengthening comprises, as represented by mole percentage based on oxides, at least from 55 to 80% of SiO₂, from 5 to 20% of Na₂O, from 0.001 to 3% of Fe₂O₃ and from 0.001 to 3% of TiO₂ and further contains as a coloring component from 0.001 to 10% of MpOq (wherein M is at least one member selected from Co, Cu, V, Cr, Pr, Ce, Bi, Eu, Mn, Er, Ni, Nd, W, Rb, Sn and Ag, and p and q represent the atomic ratio of M and O). A glass housing comprises chemically strengthened glass obtained by subjecting the glass for chemical strengthening to chemical strengthening treatment.

### TECHNICAL FIELD

The present invention relates to glass for chemical strengthening to be used for an electronic device, for example, a portable communication device or information device, and a glass housing such glass for chemical strengthening.

### BACKGROUND ART

Heretofore, a resin or a metal has been mainly used as a material of a housing for a portable communication device or information device such as a cell phone, considering the design, the scratch resistance, the processability, the cost, etc. In recent years, in addition to such a resin or a metal, use of glass which has not been used as a housing material has been attempted (for example, Patent Document 1). It is considered that a specific decorative effect with good transparency can be achieved by use of glass.

However, glass is usually fragile, and on the other hand, a housing to be used for an electronic device such as a cell phone is required to have a sufficiently high strength against breakage due to drop impact at a time of use or contact scars by a long-term use. Accordingly, glass having high strength which can be used for a housing for an electronic device such as a cell phone has been required.

Various techniques to increase the strength of glass have been known. Typical methods are a method of quenching a surface of a glass plate heated to near the softening point by air cooling or the like to form a compressive stress layer on the surface (air quenching strengthening method/physical strengthening method) and a method of exchanging alkali metal ions having a small ion radius (typically Li ions or Na ions) on a glass plate surface with alkali metal ions having a larger ion radius (typically Na ions or K ions for Li ions, and K ions for Na ions) by ion exchange at a temperature of at most the glass transition point to form a compressive stress layer on the surface of glass (chemical strengthening method). Both are to improve the strength by forming a compressive stress layer on the surface of glass.

Between these methods, by the former air quenching strengthening method, if the glass is thin (usually 3 mm or thinner) as in the case of the glass for housing, there will be less temperature difference between the surface and the interior, whereby it is difficult to form a compressive stress layer. Further, due to the dispersion of the cooling temperature, in the case of a thin glass plate, its flatness may be impaired. Whereas, by the latter chemical strengthening method, it is possible to form a compressive stress layer even on the surface of a thin glass plate, and the flatness will not be impaired. Accordingly, the glass to be used for a housing is preferably a material capable of being strengthened by the chemical strengthening method.

### PRIOR ART DOCUMENT

### Patent Document

Patent Document 1: JP-A-2009-61730

### DISCLOSURE OF INVENTION

### Technical Problem

A housing for an electronic device such as a cell phone is required to have high design property, and accordingly it is considered to use glass which itself is colored, that is, to use glass containing a coloring agent.

However, it was confirmed that such glass containing a coloring agent is to be strengthened by the above-described chemical strengthening method, it is less likely to be chemically strengthened as compared with a case where glass containing no coloring agent is chemically strengthened, that is, the strength of the chemically strengthened glass containing a coloring agent is relatively low as compared with chemically strengthened glass containing no coloring agent. The reasons are considered to be as follows. The content in the glass of alkali metal ions having a small ion radius to be exchanged with alkali metal ions having a large ion radius by ion exchange is relatively reduced by the coloring agent contained, whereby the amount to be ion exchanged is reduced, and movement of alkali metal ions is inhibited by the presence of coloring agent ions.

Further, coloring of glass is to show desired color development by letting a transition metal be present in glass in a specific valency state. However, during long term use of the glass for a housing or the like, the valency state of the transition metal may change by the influence of e.g. ultraviolet light and the color of glass may change, that is, so-called solarization may occur. Accordingly, it is desired that colored glass to be used for a housing maintains the initial colored state for a long period of time, whereby its design property is not impaired by the change of color.

It is an object of the present invention to provide glass for chemical strengthening, from which glass which has high strength, the color change of which is small even by long term use, and which has high solarization resistance, can be obtained, and a housing such glass for chemical strengthening.

### Solution to Problem

The present invention provides glass for chemical strengthening, which comprises, as represented by mole percentage based on oxides, at least from 55 to 80% of SiO₂, from 5 to 20% of Na₂O, from 0.001 to 3% of Fe₂O₃ and from 0.001 to 3% of TiO₂, and contains as a coloring component from 0.001 to 10% of MpOq (wherein M is at least one member selected from Co, Cu, V, Cr, Pr, Ce, Bi, Eu, Mn, Er, Ni, Nd, W, Rb, Sn and Ag, and p and q represent the atomic ratio of M and O) (hereinafter this glass will sometimes be referred to as glass for chemical strengthening of the present invention).

The present invention further provides glass for chemical strengthening, which comprises, as represented by mole percentage based on oxides, from 55 to 80% of SiO₂, from 3 to 16% of Al₂O₃, from 0 to 12% of B₂O₃, from 5 to 16% of Na₂O, from 0 to 5% of K₂O, from 0 to 15% of MgO, from 0 to 5% of ZnO, from 0 to 1% of RO (wherein R is at least one member selected from Sr, Ba and Ca), from 0 to 5% of ZrO₂, from 0.001 to 3% of Fe₂O₃ and from 0.001 to 3% of TiO₂, and further contains as a coloring component from 0.001 to 10% of MpOq (wherein M is at least one member selected from Co, Cu, V, Cr, Pr, Ce, Bi, Eu, Mn, Er, Ni, Nd, W, Rb, Sn and Ag, and p and q represent the atomic ratio of M and O) (hereinafter sometimes referred to as glass 1 for chemical strengthening of the present invention).

The present invention further provides glass for chemical strengthening, which comprises, as represented by mole percentage based on oxides, from 55 to 80% of SiO₂, from 3 to 16% of Al₂O₃, from 0 to 12% of B₂O₃, from 5 to 16% of Na₂O, from 0 to 15% of K₂O, from 0 to 15% of MgO, from 0 to 5% of ZnO, from 0 to 1% of RO (wherein R is at least one member selected from Sr, Ba and Ca), from 0 to 5% of ZrO₂, from 0.001 to 3% of Fe₂O₃ and from 0.001 to 3% of TiO₂, and further contains as a coloring component from 0.001 to 10% of MpOq (wherein M is at least one member selected from Co, Cu, V, Cr, Pr, Ce, Bi, Eu, Mn, Er, Ni, Nd, W, Rb, Sn and Ag, and p and q represent the atomic ratio of M and O) (hereinafter sometimes referred to as glass 2 for chemical strengthening of the present invention).

The present invention further provides glass for chemical strengthening, which comprises, as represented by mole percentage based on oxides, from 55 to 80% of SiO₂, from 0 to 5% of Al₂O₃, from 0 to 12% of B₂O₃, from 5 to 20% of Na₂O, from 0 to 8% of K₂O, from 1 to 15% of CaO, from 0 to 5% of ZnO, from 0 to 10% of RO (wherein R is at least one member selected from Sr, Ba and Mg), from 0 to 5% of ZrO₂, from 0.001 to 3% of Fe₂O₃ and from 0.001 to 3% of TiO₂, and further contains as a coloring component from 0.001 to 10% of MpOq (wherein M is at least one member selected from Co, Cu, V, Cr, Pr, Ce, Bi, Eu, Mn, Er, Ni, Nd, W, Rb, Sn and Ag, and p and q represent the atomic ratio of M and O) (hereinafter this glass will sometimes be referred to as glass 3 for chemical strengthening of the present invention).

The present invention further provides any one of the glasses 1 to 3 for chemical strengthening of the present invention, which contains as the coloring component from 0 to 3% of Co₃O₄ and from 0 to 8% of CuO in a total content of from 0.01 to 8%.

In such glass for chemical strengthening, the transmission color tone measured by using illuminant C in a thickness of 2 mm, as represented by the value (x,y) on the CIE chromaticity coordinate, may satisfy the following conditions:

0.00≦x≦0.32

0.00≦y≦0.40

The present invention further provides any one of the glasses 1 to 3 for chemical strengthening of the present invention, which contains as the coloring component from 0 to 5% of V₂O₅, from 0 to 5% of Cr₂O₃, from 0 to 8% of CuO and from 0 to 3% of Pr₆O₁₁ in a total content of from 0.01 to 8%.

In such glass for chemical strengthening, the transmission color tone measured by using illuminant C in a thickness of 2 mm, as represented by the value (x,y) on the CIE chromaticity coordinate, may satisfy the following conditions:

0.00≦x≦0.42

0.31≦y≦0.78

Further, the present invention provides any one of the glasses 1 to 3 for chemical strengthening of the present invention, which contains as the coloring component from 0 to 3% of CeO₂, from 0 to 5% of V₂O₅, from 0 to 10% of Bi₂O₃ and from 0 to 3% of Eu₂O₃ in a total content of from 0.01 to 10%.

In such glass for chemical strengthening, the transmission color tone measured by using illuminant C in a thickness of 2 mm, as represented by the value (x,y) on the CIE chromaticity coordinate, may satisfy the following conditions:

0.31≦x≦0.66

0.31≦y≦0.58

The present invention further provides any one of the glasses 1 to 3 for chemical strengthening of the present invention, which contains as the coloring component from 0 to 10% of MnO₂, from 0 to 3% of ErO₂, from 0 to 5% of NiO, from 0 to 3% of Nd₂O₃ and from 0 to 10% of WO₃ in a total content of from 0.01 to 10%.

In such glass for chemical strengthening, the transmission color tone measured by using illuminant C in a thickness of 2 mm, as represented by the value (x,y) on the CIE chromaticity coordinate, may satisfy the following conditions:

0.26≦x≦0.50

0.04≦y≦0.34

The present invention further provides any one of the glasses 1 to 3 for chemical strengthening of the present invention, which further contains from 0 to 3% of SnO and from 0 to 5% of Sb₂O₃ and which contains as the coloring component from 0 to 3% of Cu₂O and from 0 to 6% of Ag₂O, in a total content of SnO and Sb₂O₃ of from 0.01 to 5% and in a total content of Cu₂O and Ag₂O of from 0.001 to 6%.

In such glass for chemical strengthening, the transmission color tone measured by using illuminant C in a thickness of 2 mm after subjected to heat treatment under desired conditions, as represented by the value (x,y) on the CIE chromaticity coordinate, may satisfy the following conditions:

0.31≦x≦0.73

0.20≦y≦0.35

The present invention further provides the glass for chemical strengthening of the present invention, wherein the transmittance deterioration degree ΔT as obtained by the following formula is at most 5%:

ΔT(%)=[(T0−T1)/T0]×100

wherein T1 is the average transmittance at wavelengths of from 380 nm to 780 nm in a spectral transmittance curve obtained after a polished surface of glass having a thickness of 2 mm having both surfaces optically mirror-polished, is irradiated with light of a 400 W high pressure mercury lamp with a distance of 15 cm for 50 hours, and T0 is the average transmittance at wavelengths of from 380 nm to 780 nm in a spectral transmittance curve before light irradiation.

The present invention further provides the glass for chemical strengthening of the present invention, which is glass to be used for forming chemically strengthened glass having a compressive stress layer having a thickness of at least 30 μm and a surface compressive stress of at least 550 MPa formed on the glass surface by chemical strengthening treatment.

The present invention further provides a glass housing comprising chemically strengthened glass obtained by subjecting the glass for chemical strengthening of the present invention to chemical strengthening treatment (hereinafter sometimes referred to as glass housing of the present invention).

The present invention further provides the glass housing of the present invention,

wherein the chemically strengthened glass has a thickness of at least 0.5 mm.

The present invention further provides the glass housing of the present invention, wherein the chemically strengthened glass has a compressive stress layer having a thickness of at least 30 μm and a surface compressive stress of at least 550 MPa formed on its surface by the chemical strengthening treatment.

The present invention further provides the glass housing of the present invention, which is a glass housing to be used to accommodate an electronic device.

In this specification, “to” used to show the range of the numerical value is used to include the numerical values before and after it as the lower limit value and the upper limit value, and unless otherwise specified, the same applies hereinafter.

### Advantageous Effects of Invention

According to the present invention, it is possible to provide glass for chemical strengthening, from which glass which has high strength, the color change of which is small even by long term use and which has high solarization resistance, can be obtained, and a housing comprising such glass for chemical strengthening.

### BRIEF DESCRIPTION OF DRAWING

FIGS. 1(a) and (b) are drawings illustrating spectral transmittance curves measured with respect to glasses in one Example of the present invention and one Comparative Example.

### DESCRIPTION OF EMBODIMENTS

Now, the embodiments of the present invention will be described.

### First Embodiment

First, glass for chemical strengthening according to a first embodiment of the glass 1 for chemical strengthening of the present invention will be described. In this embodiment and the following embodiments, the glass composition is described with reference to a content as represented by mol % as calculated as the following oxides, unless otherwise specified. Hereinafter “mol %” may sometimes be referred to simply as “%”.

The glass for chemical strengthening according to a first embodiment comprises SiO₂, Al₂O₃, Na₂O, Fe₂O₃, TiO₂, and a coloring component MpOq (wherein M is at least one member selected from Co, Cu, V, Cr, Pr, Ce, Bi, Eu, Mn, Er, Ni, Nd, W, Rb, Sn and Ag, and p and q represent the atomic ratio of M and O) as essential components.

The composition of the glass for chemical strengthening according to the first embodiment is as follows.

SiO₂: 55 to 80%,

Al₂O₃: 3 to 16%,

Na₂O: 5 to 16%,

Fe₂O₃: 0.001 to 3%,

TiO₂: 0.001 to 3%,

MpOq: 0.001 to 10% (wherein M is at least one member selected from Co, Cu, V, Cr, Pr, Ce, Bi, Eu, Mn, Er, Ni, Nd, W and Ag, and p and q represent the atomic ratio of M and O),

B₂O₃: 0 to 12%,

K₂O: 0 to 5%,

MgO: 0 to 15%,

ZnO: 0 to 5%,

ZrO₂: 0 to 5%,

RO: 0 to 1% (wherein R is at least one member selected from Sr, Ba and Ca).

SiO₂ which is an essential component of the glass for chemical strengthening according to this embodiment is a component constituting a glass matrix. If its content is less than 55%, the stability as the glass tends to be low, or the weather resistance tends to be low. Accordingly, it is contained in a content of at least 55%. Its content is preferably at least 58%, more preferably at least 60%. Further, if the content exceeds 80%, the viscosity of the glass tends to increase, and the melting property tends to be low. Accordingly, the content is at most 80%. It is preferably at most 78%, more preferably at most 75%.

Al₂O₃ is a component to improve the weather resistance of the glass. If its content is less than 3%, the weather resistance tends to be low. Accordingly, it is contained in a content of at least 3%. Its content is preferably at least 4%, more preferably at least 5%. Further, if the content exceeds 16%, the viscosity of the glass tends to be high, whereby homogenous melting tends to be difficult. Accordingly, the content is at most 16%. It is preferably at most 14%, more preferably at most 12%.

Na₂O is a component to improve the melting property of the glass and is a component necessary to form a compressive stress layer on the glass surface by ion exchange. If its content is less than 5%, the melting property tends to be low, and it tends to be difficult to form a desired compressive stress layer on the glass surface by ion exchange. Accordingly, it is contained in a content of at least 5%. Its content is preferably at least 6%, more preferably at least 8%. Further, if the content exceeds 16%, the weather resistance tends to be low. Accordingly, the content is at most 16%. It is preferably at most 15%, more preferably at most 14%.

Fe₂O₃ is a component to facilitate movement of ions in the glass to promote ion exchange. If its content is less than 0.001%, no effect to promote ion exchange will be obtained. Accordingly, it is contained in a content of at least 0.001%. Its content is preferably at least 0.01%, more preferably at least 0.03%. Further, if the content exceeds 3%, the glass tends to be unstable, and is likely to be devitrified. Accordingly, the content is at most 3%. It is preferably at most 2.8%, more preferably at most 2.5%.

The reason why ion exchange is promoted by addition of Fe₂O₃ is considered that by presence of 4-coordinated Fe³⁺ in the glass, non-bridging oxygen in the glass is converted to bridging oxygen and as a result, a negative charge density is lowered, and Na⁺ ions are likely to be moved.

Fe₂O₃ makes the glass yellow or green depending upon the valency state of Fe ions. In the case of Fe²⁺, the glass will be green to bluish green, and in the case of Fe³⁺, the glass will be yellow. For promotion of chemical strengthening which is a great characteristic of the present invention, a state of Fe³⁺ is preferred, and it is preferably melted in an oxidizing condition, however, usually both Fe²⁺ and Fe³⁺ are present in the glass, and not all the iron ions can be in a Fe³⁺ state. Accordingly, in a case where the Fe₂O₃ content is high, Fe²⁺ which is present in a small amount may color the glass, and in such a case, the glass will be colored green, and accordingly it is possible to use Fe₂O₃ in combination with the above-described green coloring agent. The degree to color the glass yellow by Fe³⁺ is low, but in the same way of thinking, Fe₂O₃ may be used in combination with the above-described yellow coloring agent.

TiO₂ is a component having an effect to increase the solarization resistance of the glass and an effect to increase coloring by other colored ions. If its content is less than 0.001%, the solarization resistance will not be improved. Accordingly, it is contained in a content of at least 0.001%. Its content is preferably at least 0.01%, more preferably at least 0.02%. Further, if the content exceeds 3%, the crystallization tendency of the glass will be increased, and devitrification tends to occur. Accordingly, the content is at most 3%. It is preferably at most 2.8%, more preferably at most 2.5%.

The coloring component MpOq (wherein M is at least one member selected from Co, Cu, V, Cr, Pr, Ce, Bi, Eu, Mn, Er, Ni, Nd, W, Rb, Sn and Ag, and p and q represent the atomic ratio of M and O) is a component to color the glass in a desired color, and by properly selecting the coloring component, it is possible to obtain colored glass, for example, blue, green, yellow, violet to pink, or red glass.

Specifically, for example, by use of at least one member selected from Co₃O₄ and CuO, blue glass can be obtained. By use of at least one member selected from V₂O₅, Cr₂O₃, CuO and Pr₆O₁₁, green glass can be obtained. By use of at least one member selected from CeO₂, V₂O₅, Bi₂O₃ and Eu₂O₃, yellow glass can be obtained. By use of at least one member selected from MnO₂, Er₂O₃, NiO, Nd₂O₃ and WO₃, violet to pink glass can be obtained.

Further, by use of at least one member selected from Cu₂O and Ag₂O, red glass can be obtained.

If the content of the coloring component MpOq is less than 0.001%, coloring of the glass tends to be very thin, and accordingly the glass will not be recognized as colored unless it is very thick, and it is necessary to design the glass rather thick so that an obtainable colored housing has a design property. Accordingly, MpOq is contained in a content of at least 0.001%. Its content is preferably at least 0.05%, more preferably at least 0.1%. Further, if the content exceeds 10%, the glass tends to be unstable. Accordingly, the content is at most 10%. It is preferably at most 8%, more preferably at most 5%.

The glass for chemical strengthening according to this embodiment may contain, as the case requires, B₂O₃, K₂O, MgO, ZnO, RO (wherein R is at least one member selected from Sr, Ba and Ca) and ZrO₂.

By B₂O₃, the weather resistance can be improved. However, if its content is less than 0.1%, no significant effect to improve the weather resistance may be obtained. Accordingly, it is preferably contained in a content of at least 0.1%. Its content is more preferably at least 0.5%, particularly preferably at least 2%. Further, if the content exceeds 12%, striae may form by volatilization, thus lowering the yield. Accordingly, the content is at most 12%. It is preferably at most 10%, more preferably at most 8%.

By K₂O, the melting property can be improved, and the ion exchange rate in chemical strengthening can be made high. However, if its content is less than 0.1%, no significant effect to improve the melting property may be obtained, or no significant effect to improve the ion exchange rate may be obtained. Accordingly, it is preferably contained in a content of at least 0.1%. Its content is more preferably at least 0.2%, particularly preferably at least 0.5%. Further, if the content exceeds 5%, the weather resistance tends to be low. Accordingly, the content is at most 5%, preferably at most 4.5%, more preferably at most 4%.

By MgO, the melting property can be improved. However, if its content is less than 0.1%, no significant effect to improve the melting property may be obtained. Accordingly, it is preferably contained in a content of at least 0.1%. Its content is more preferably at least 0.2%, particularly preferably at least 0.5%. Further, if the content exceeds 15%, the weather resistance tends to be low. Accordingly, the content is at most 15%. It is preferably at most 14%, more preferably at most 12%.

By ZnO, the weather resistance can be improved. However, if its content is less than 0.1%, no significant effect to improve the weather resistance may be obtained. Accordingly, it is preferably contained in a content of at least 0.1%. Its content is preferably at least 0.2%, particularly preferably at least 0.3%. Further, if the content exceeds 5%, the glass tends to be unstable. Accordingly, the content is at most 5%. It is preferably at most 4%, more preferably at most 3%.

By RO (wherein R is at least one member selected from Sr, Ba and Ca), the melting property can be improved. However, on the contrary, the chemical strengthening properties may be deteriorated, and accordingly its addition should be limited to the minimum amount required, and its content is preferably at most 1% in total, more preferably at most 0.5%.

By ZrO₂, the ion exchange rate can be increased. However, if its content is less than 0.01%, no significant effect to improve the ion exchange rate may be obtained. Accordingly, it is preferably contained in a content of at least 0.01%. Its content is more preferably at least 0.05%, particularly preferably at least 0.1%. Further, if the content exceeds 5%, the melting property tends to be low, whereby ZrO₂ may remain in the glass as an unmelted substance. Accordingly, its content is at most 5%. It is preferably at most 4%, more preferably at most 3%.

The glass for chemical strengthening according to this embodiment may further contain SO₃, SnO or Sb₂O₃ as the case requires.

SO₃ is a component which functions as a clarifying agent. However, if its content is less than 0.01%, no desired clarifying effect may be obtained. Accordingly, in a case where SO₃ is contained, it is preferably contained in a content of at least 0.01%. Its content is more preferably at least 0.03%, particularly preferably at least 0.05%. However, if the content exceeds 1%, SO₃ may rather be a source of bubbles, whereby melting of the glass tends to be slow, or the number of bubbles may increase. Accordingly, the content is preferably at most 1%. It is more preferably at most 0.8%, particularly preferably at most 0.6%.

SnO functions, in a case where the glass is to be colored red, as a so-called heat reducing agent which reduces Cu₂O or Ag₂O to precipitate Cu or Ag colloid in the subsequent heat treatment. However, if its content is less than 0.05%, no desired effect as a heat reducing agent may be obtained. Accordingly, in a case where SnO is contained, it is preferably contained in a content of at least 0.05%. Its content is more preferably at least 0.1%, particularly preferably at least 0.2%. Further, if the content exceeds 3%, the glass tends to be unstable, and is likely to be devitrified. Accordingly, the content is preferably at most 3%. It is more preferably at most 2.8%, particularly preferably at most 2.5%.

Sb₂O₃ has a function, in a case where the glass is to be colored red, as a heat reducing agent like SnO. However, if its content is less than 0.05%, no desired effect as a heat reducing agent may be obtained. Accordingly, in a case where Sb₂O₃ is contained, it is preferably contained in a content of at least 0.05%. Its content is more preferably at least 0.1%, particularly preferably at least 0.2%. Further, if the content exceeds 5%, the glass tends to be unstable and is likely to be devitrified. Accordingly, the content is preferably at most 5%. It is more preferably at most 3%, particularly preferably at most 1%. Since Sb₂O₃ is a substance of concern, it is preferred to use SnO as a heat reducing agent.

The glass for chemical strengthening according to the first embodiment of the glass 1 for chemical strengthening of the present invention was described above. However, the glass for chemical strengthening according to a first embodiment of the glass 2 for chemical strengthening of the present invention is the same as the glass for chemical strengthening according to the first embodiment of the glass 1 for chemical strengthening except that the K₂O content is from 0 to 15%. By incorporating K₂O, the melting property can be improved, and the ion exchange rate in chemical strengthening can be made high. However, if its content is less than 0.1%, no significant effect to improve the melting property may be obtained, or no significant effect to improve the ion exchange rate may be obtained. Accordingly, it is preferably contained in a content of at least 0.1%. Its content is more preferably at least 0.2%, particularly preferably at least 0.5%. Further, if the content exceeds 15%, cracking is likely to occur from an indentation if the glass surface has an indentation, whereby the glass strength tends to be low. Accordingly, the content is at most 15%. It is preferably at most 12%, more preferably at most 10%.

The glass for chemical strengthening according to this embodiment, particularly by containing Fe₂O₃ and TiO₂, has excellent solarization resistance and can have a compressive stress layer having sufficient depth and surface compressive stress formed on its surface by applying chemical strengthening treatment, whereby colored chemically strengthened glass having high strength can be obtained. The obtained chemically strengthened glass is useful as a material of a glass housing to accommodate an electronic device.

The method for producing the glass for chemical strengthening according to this embodiment is not particularly limited, and the glass for chemical strengthening is produced, for example, in such a manner that appropriate amounts of various raw materials are mixed, heated to about 1,500 to 1,600° C. and melted, homogenized by degassing, stirring or the like, and formed into a plate by a known down draw method, pressing method or the like or formed into a block by casting, and the plate or the block is annealed and cut into a desired size, followed by polishing as the case requires.

Further, the method of chemically strengthening the glass for chemical strengthening according to this embodiment is not particularly limited so long as Na₂O in the glass surface layer and K₂O in the molten salt can be ion exchanged, and for example, a method of dipping a glass plate or a glass formed product in a potassium nitrate (KNO₃) molten salt heated to from 400 to 550° C. for from 2 to 20 hours may be used.

Of the glass for chemical strengthening according to this embodiment, the transmittance deterioration degree ΔT obtained from the following formula is preferably at most 5%, more preferably at most 4%.

ΔT(%)=[(T0−T1)/T0]×100

wherein T1 is the average transmittance at wavelengths of from 380 nm to 780 nm in a spectral transmittance curve obtained after a polished surface of glass for chemical strengthening having a thickness of 2 mm having both surfaces optically mirror-polished, is irradiated with light of a 400 W high pressure mercury lamp with a distance of 15 cm for 50 hours, and T0 is the average transmittance at wavelengths of from 380 nm to 780 nm in a spectral transmittance curve before light irradiation.

This transmittance deterioration degree is an index to evaluate the solarization resistance of the glass for chemical strengthening.

### Second Embodiment

Now, the glass for chemical strengthening according to a second embodiment of the present invention will be described.

The glass for chemical strengthening according to a second embodiment is glass colored blue, and for example, glass having a color tone which satisfies, as represented by the value (x,y) on the CIE chromaticity coordinate, 0.00≦x≦0.32 and 0.00≦y≦0.40, can be obtained.

The glass for chemical strengthening according to a second embodiment of the glass 1 for chemical strengthening of the present invention comprises SiO₂, Al₂O₃, Na₂O, Fe₂O₃, TiO₂, and a coloring component Co₃O₄ and/or CuO (i.e. at least one member selected from the group consisting of Co₃O₄ and CuO) as essential components.

The composition of the glass for chemical strengthening according to the second embodiment is as follows.

SiO₂: 55 to 80%,

Al₂O₃: 3 to 16°/O,

Na₂O: 5 to 16%,

B₂O₃: 0 to 12%,

Fe₂O₃: 0.001 to 3%,

TiO₂: 0.001 to 3%,

Co₃O₄: 0 to 3%,

CuO: 0 to 8%,

(Co₃O₄+CuO): 0.01 to 8%,

B₂O₃: 0 to 12%,

K₂O: 0 to 5%,

MgO: 0 to 15%,

ZnO: 0 to 5%,

ZrO₂: 0 to 5%,

RO: 0 to 1% (wherein R is at least one member selected from Sr, Ba and Ca).

SiO₂ which is an essential component of the glass for chemical strengthening according to this embodiment is a component constituting a glass matrix. If its content is less than 55%, the stability as the glass tends to be low, or the weather resistance tends to be low. Accordingly, it is contained in a content of at least 55%. Its content is preferably at least 58%, more preferably at least 60%. Further, if the content exceeds 80%, the viscosity of the glass tends to increase, and the melting property tends to be low. Accordingly, the content is at most 80%. It is preferably at most 78%, more preferably at most 75%.

Al₂O₃ is a component to improve the weather resistance of the glass. If its content is less than 3%, the weather resistance tends to be low. Accordingly, it is contained in a content of at least 3%. Its content is preferably at least 4%, more preferably at least 5%. Further, if the content exceeds 16%, the viscosity of the glass tends to be high, whereby homogenous melting tends to be difficult. Accordingly, the content is at most 16%. It is preferably at most 14%, more preferably at most 12%.

Na₂O is a component to improve the melting property of the glass and is a component necessary to form a compressive stress layer on the glass surface by ion exchange. If its content is less than 5%, the melting property tends to be low, and it tends to be difficult to form a desired compressive stress layer on the glass surface by ion exchange. Accordingly, it is contained in a content of at least 5%. Its content is preferably at least 6%, more preferably at least 8%. Further, if the content exceeds 16%, the weather resistance tends to be low. Accordingly, the content is at most 16%. It is preferably at most 15%, more preferably at most 14%.

Fe₂O₃ is a component to facilitate movement of ions in the glass to promote ion exchange. If its content is less than 0.001%, no effect to promote ion exchange will be obtained. Accordingly, it is contained in a content of at least 0.001%. Its content is preferably at least 0.01%, more preferably at least 0.03%. Further, if the content exceeds 3%, the glass tends to be unstable, and is likely to be devitrified. Accordingly, the content is at most 3%. It is preferably at most 2.8%, more preferably at most 2.5%.

The reason why ion exchange is promoted by addition of Fe₂O₃ is considered that by presence of 4-coordinated Fe³⁺ in the glass, non-bridging oxygen in the glass is converted to bridging oxygen and as a result, a negative charge density is lowered, and Na⁺ ions are likely to be moved.

TiO₂ is a component having an effect to increase the solarization resistance of the glass and an effect to increase coloring by other colored ions. If its content is less than 0.001%, the solarization resistance will not be improved. Accordingly, it is contained in a content of at least 0.001%. Its content is preferably at least 0.01%, more preferably at least 0.02%. Further, if the content exceeds 3%, the crystallization tendency of the glass will be increased, and devitrification tends to occur. Accordingly, the content is at most 3%. It is preferably at most 2.8%, more preferably at most 2.5%.

At least one member selected from the group consisting of Co₃O₄ and CuO contained as the coloring component is an essential component to color the glass blue. If the content of Co₃O₄ or CuO or the total content of Co₃O₄ and CuO is less than 0.01%, no desired blue glass will be obtained. Accordingly, at least one of them is contained in a content of at least 0.01%. The content is preferably at least 0.05%, more preferably at least 0.1%. Further, if the content exceeds 8%, the glass tends to be unstable. Accordingly, the content is at most 8%. It is preferably at most 7%, more preferably at most 6%.

However, if the content of Co₃O₄ exceeds 3%, the coloring tends to be too deep, whereby the design property tends to be low. Accordingly, the content of Co₃O₄ is at most 3%. It is preferably at most 2.8%, more preferably at most 2.5%. Further, if the CuO content exceeds 8%, the coloring tends to be too deep and the glass tends to be unstable. Accordingly, the content of CuO is at most 8%. It is preferably at most 7%, more preferably at most 5%.

In this embodiment, the glass may contain at least one member selected from a coloring component MpOq (wherein M is at least one member selected from V, Cr, Pr, Ce, Bi, Eu, Mn, Er, Ni, Nd, W, Rb, Sn and Ag, and p and q represent the atomic ratio of M and O) other than the above coloring components, within a range not to impair coloring in blue. In such a case, the total content with the above coloring components is preferably not higher than 10%. If the content exceeds 10%, the glass tends to be unstable. It is preferably at most 9%, more preferably at most 8%.

The glass for chemical strengthening according to this embodiment may contain, as the case requires, B₂O₃, K₂O, MgO, ZnO, RO (wherein R is at least one member selected from Sr, Ba and Ca) and ZrO₂.

By B₂O₃, the weather resistance can be improved. However, if its content is less than 0.1%, no significant effect to improve the weather resistance may be obtained. Accordingly, it is preferably contained in a content of at least 0.1%. Its content is more preferably at least 0.5%, particularly preferably at least 2%. Further, if the content exceeds 12%, striae may form by volatilization, thus lowering the yield. Accordingly, the content is at most 12%. It is preferably at most 10%, more preferably at most 8%.

By K₂O, the melting property can be improved, and the ion exchange rate in chemical strengthening can be made high. However, if its content is less than 0.1%, no significant effect to improve the melting property may be obtained, or no significant effect to improve the ion exchange rate may be obtained. Accordingly, it is preferably contained in a content of at least 0.1%. Its content is more preferably at least 0.2%, particularly preferably at least 0.5%. Further, if the content exceeds 5%, the weather resistance tends to be low. Accordingly, the content is at most 5%. It is preferably at most 4.5%, more preferably at most 4%.

By MgO, the melting property can be improved. However, if its content is less than 0.1%, no significant effect to improve the melting property may be obtained. Accordingly, it is preferably contained in a content of at least 0.1%. The content is more preferably at least 0.2%, particularly preferably at least 0.5%. Further, if the content exceeds 15%, the weather resistance tends to be low. Accordingly, the content is at most 15%. It is preferably at most 14%, more preferably at most 12%.

By ZnO, the weather resistance can be improved. However, if its content is less than 0.1%, no significant effect to improve the weather resistance may be obtained. Accordingly, it is preferably contained in a content of at least 0.1%. Its content is preferably at least 0.2%, particularly preferably at least 0.3%. Further, if the content exceeds 5%, the glass tends to be unstable. Accordingly, the content is at most 5%. It is preferably at most 4%, more preferably at most 3%.

By RO (wherein R is at least one member selected from Sr, Ba and Ca), the melting property can be improved. However, on the contrary, the chemical strengthening properties may be deteriorated, and accordingly its addition should be limited to the minimum amount required, and its content is preferably at most 1% in total, more preferably at most 0.5%.

By ZrO₂, the ion exchange rate can be increased. However, if its content is less than 0.01%, no significant effect to improve the ion exchange rate may be obtained. Accordingly, it is preferably contained in a content of at least 0.01%. Its content is more preferably at least 0.05%, particularly preferably at least 0.1%. Further, if the content exceeds 5%, the melting property tends to be low, whereby ZrO₂ may remain in the glass as an unmelted substance. Accordingly, its content is at most 5%. It is preferably at most 4%, more preferably at most 3%.

The glass for chemical strengthening according to this embodiment may further contain SO₃ as the case requires.

SO₃ is a component which functions as a clarifying agent. However, if its content is less than 0.01%, no desired clarifying effect may be obtained. Accordingly, in a case where SO₃ is contained, it is preferably contained in a content of at least 0.01%. Its content is more preferably at least 0.03%, particularly preferably at least 0.05%. However, if the content exceeds 1%, SO₃ may rather be a source of bubbles, whereby melting of the glass tends to be slow, or the number of bubbles may increase. Accordingly, the content is preferably at most 1%. It is more preferably at most 0.8%, particularly preferably at most 0.6%.

The glass for chemical strengthening according to the second embodiment of the glass 1 for chemical strengthening of the present invention was described above. However, the glass for chemical strengthening according to a second embodiment of the glass 2 for chemical strengthening of the present invention is the same as the glass for chemical strengthening according to the second embodiment of the glass 1 for chemical strengthening except that the K₂O content is from 0 to 15%. By incorporating K₂O, the melting property can be improved, and the ion exchange rate in chemical strengthening can be made high. However, if its content is less than 0.1%, no significant effect to improve the melting property may be obtained, or no significant effect to improve the ion exchange rate may be obtained. Accordingly, it is preferably contained in a content of at least 0.1%. Its content is more preferably at least 0.2%, particularly preferably at least 0.5%. Further, if the content exceeds 15%, cracking is likely to occur from an indentation if the glass surface has an indentation, whereby the glass strength tends to be low. Accordingly, the content is at most 15%. It is preferably at most 12%, more preferably at most 10%.

The glass for chemical strengthening according to this embodiment, particularly by containing Fe₂O₃ and TiO₂, has excellent solarization resistance and can have a compressive stress layer having sufficient depth and surface compressive stress formed on its surface by applying chemical strengthening treatment, whereby blue chemically strengthened glass having high strength can be obtained.

The method for producing the glass for chemical strengthening according to this embodiment is not particularly limited, and the glass for chemical strengthening is produced, for example, in such a manner that appropriate amounts of various raw materials are mixed, heated to about 1,500 to 1,600° C. and melted, homogenized by degassing, stirring or the like, and formed into a plate by a known down draw method, pressing method or the like or formed into a block by casting, and the plate or the block is annealed and cut into a desired size, followed by polishing as the case requires.

Further, the method of chemically strengthening the glass for chemical strengthening according to this embodiment is not particularly limited so long as Na₂O in the glass surface layer and K₂O in the molten salt can be ion exchanged, and for example, a method of dipping a glass plate or a glass formed product in a potassium nitrate (KNO₃) molten salt heated to from 400 to 550° C. for from 2 to 20 hours may be used.

Of the glass for chemical strengthening according to this embodiment, the transmittance deterioration degree ΔT obtained from the following formula is preferably at most 5%, more preferably at most 4%.

ΔT(%)=[(T0−T1)/T0]×100

wherein T1 is the average transmittance at wavelengths of from 380 nm to 780 nm in a spectral transmittance curve obtained after a polished surface of glass for chemical strengthening having a thickness of 2 mm having both surfaces optically mirror-polished, is irradiated with light of a 400 W high pressure mercury lamp with a distance of 15 cm for 50 hours, and T0 is the average transmittance at wavelengths of from 380 nm to 780 nm in a spectral transmittance curve before light irradiation.

### Third Embodiment

Now, the glass for chemical strengthening according to a third embodiment of the present invention will be described.

The glass for chemical strengthening according to a third embodiment is glass colored green, and for example, glass having a color tone which satisfies, as represented by the value (x,y) on the CIE chromaticity coordinate, 0.00≦x≦0.42 and 0.31≦y≦0.78, can be obtained.

The glass for chemical strengthening according to a third embodiment of the glass 1 for chemical strengthening of the present invention comprises SiO₂, Al₂O₃, Na₂O, Fe₂O₃, TiO₂, and as a coloring component, at least one member selected from V₂O₅, Cr₂O₃, CuO and Pr₆O₁₁ as essential components.

The composition of the glass for chemical strengthening according to the third embodiment is as follows.

SiO₂: 55 to 80%,

Al₂O₃: 3 to 16%,

Na₂O: 5 to 16%,

B₂O₃: 0 to 12%,

Fe₂O₃: 0.001 to 3%,

TiO₂: 0.001 to 3%,

V₂O₅: 0 to 5%,

Cr₂O₃: 0 to 5%,

CuO: 0 to 8%,

Pr₆O₁₁: 0 to 3%,

(V₂O₅+Cr₂O₃+CuO+Pr₆O₁₁): 0.01 to 8%,

B₂O₃: 0 to 12%,

K₂O: 0 to 5%,

MgO: 0 to 15%,

ZnO: 0 to 5%,

ZrO₂: 0 to 5%,

RO: 0 to 1% (wherein R is at least one member selected from Sr, Ba and Ca).

SiO₂ which is an essential component of the glass for chemical strengthening according to this embodiment is a component constituting a glass matrix. If its content is less than 55%, the stability as the glass tends to be low, or the weather resistance tends to be low. Accordingly, it is contained in a content of at least 55%. Its content is preferably at least 58%, more preferably at least 60%. Further, if the content exceeds 80%, the viscosity of the glass tends to increase, and the melting property tends to be low. Accordingly, the content is at most 80%. It is preferably at most 78%, more preferably at most 75%.

Al₂O₃ is a component to improve the weather resistance of the glass. If its content is less than 3%, the weather resistance tends to be low. Accordingly, it is contained in a content of at least 3%. Its content is preferably at least 4%, more preferably at least 5%. Further, if the content exceeds 16%, the viscosity of the glass tends to be high, whereby homogenous melting tends to be difficult. Accordingly, the content is at most 16%. It is preferably at most 14%, more preferably at most 12%.

Na₂O is a component to improve the melting property of the glass and is a component necessary to form a compressive stress layer on the glass surface by ion exchange. If its content is less than 5%, the melting property tends to be low, and it tends to be difficult to form a desired compressive stress layer on the glass surface by ion exchange. Accordingly, it is contained in a content of at least 5%. Its content is preferably at least 6%, more preferably at least 8%. Further, if the content exceeds 16%, the weather resistance tends to be low. Accordingly, the content is at most 16%. It is preferably at most 15%, more preferably at most 14%.

Fe₂O₃ is a component to facilitate movement of ions in the glass to promote ion exchange. If its content is less than 0.001%, no effect to promote ion exchange will be obtained. Accordingly, it is contained in a content of at least 0.001%. Its content is preferably at least 0.01%, more preferably at least 0.03%. Further, if the content exceeds 3%, the glass tends to be unstable, and is likely to be devitrified. Accordingly, the content is at most 3%. It is preferably at most 2.8%, more preferably at most 2.5%.

The reason why ion exchange is promoted by addition of Fe₂O₃ is considered that by presence of 4-coordinated Fe³⁺ in the glass, non-bridging oxygen in the glass is converted to bridging oxygen and as a result, a negative charge density is lowered, and Na⁺ ions are likely to be moved.

Fe₂O₃ makes the glass yellow or green depending upon the valency state of Fe ions. In the case of Fe²⁺, the glass will be green to bluish green, and in the case of Fe³⁺, the glass will be yellow. For promotion of chemical strengthening which is a great characteristic of the present invention, a state of Fe³⁺ is preferred, and it is preferably melted in an oxidizing condition, however, usually both Fe²⁺ and Fe³⁺ are present in the glass, and not all the iron ions can be in a Fe³⁺ state. Accordingly, in a case where the Fe₂O₃ content is high, Fe²⁺ which is present in a small amount may color the glass, and in such a case, the glass will be colored green, and accordingly it is possible to use Fe₂O₃ in combination with the above-described green coloring agent.

TiO₂ is a component having an effect to increase the solarization resistance of the glass and an effect to increase coloring by other colored ions. If its content is less than 0.001%, the solarization resistance will not be improved. Accordingly, it is contained in a content of at least 0.001%. Its content is preferably at least 0.01%, more preferably at least 0.02%. Further, if the content exceeds 3%, the crystallization tendency of the glass will be increased, and devitrification tends to occur. Accordingly, the content is at most 3%. It is preferably at most 2.8%, more preferably at most 2.5%.

At least one member selected from V₂O₅, Cr₂O₃, CuO and Pr₆O₁₁ contained as the coloring component is a component essential to color the glass green. If the content of the coloring component is less than 0.01%, no desired green glass will be obtained. Accordingly, at least one member is contained in a content of at least 0.01%. The content is preferably at least 0.05%, more preferably at least 0.1%. Further, if the content exceeds 8%, the coloring of the glass tends to be too deep, whereby the color difference will hardly be recognizable. Accordingly, the content is at most 8%. It is preferably at most 7%, more preferably at most 5%.

However, if the content of V₂O₅ exceeds 5%, the color tends to be too deep. Accordingly, the content of V₂O₅ is at most 5%. It is preferably at most 4%, more preferably at most 3%. The V ions make the glass green in a trivalent state, and accordingly it is preferably melted in a reducing condition. If the content of Cr₂O₃ exceeds 5%, the color tends to be too deep. Accordingly, the content of Cr₂O₃ is at most 5%. It is preferably at most 4%, more preferably at most 3%. If the CuO content exceeds 8%, the glass tends to be unstable. Accordingly, the content of CuO is at most 8%. It is preferably at most 7%, more preferably at most 5%. If the content of Pr₆O₁₁ exceeds 3%, the material cost tends to be high since it is an expensive material Accordingly, the content of Pr₆O₁₁ is at most 3%. It is preferably at most 2.8%, more preferably at most 2.5%.

In this embodiment, the glass may contain at least one member selected from a coloring component MpOq (wherein M is at least one member selected from Co, Ce, Bi, Eu, Mn, Er, Ni, Nd, W, Rb, Sn and Ag, and p and q represent the atomic ratio of M and O) other than above coloring components, within a range not to impair coloring in green. In such a case, the total content with the above coloring components is preferably not higher than 10%. If the content exceeds 10%, the glass tends to unstable. The content is preferably at most 9%, more preferably at most 8%.

The glass for chemical strengthening according to this embodiment may contain B₂O₃, K₂O, MgO, ZnO, RO (wherein R is at least one member selected from Sr, Ba and Ca) and ZrO₂ as the case requires.

By B₂O₃, the weather resistance can be improved. However, if its content is less than 0.1%, no significant effect to improve the weather resistance may be obtained. Accordingly, it is preferably contained in a content of at least 0.1%. Its content is more preferably at least 0.5%, particularly preferably at least 2%. Further, if the content exceeds 12%, striae may form by volatilization, thus lowering the yield. Accordingly, the content is at most 12%. It is preferably at most 10%, more preferably at most 8%.

By K₂O, the melting property can be improved, and the ion exchange rate in chemical strengthening can be made high. However, if its content is less than 0.1%, no significant effect to improve the melting property may be obtained, or no significant effect to improve the ion exchange rate may be obtained. Accordingly, it is preferably contained in a content of at least 0.1%. Its content is more preferably at least 0.2%, particularly preferably at least 0.5%. Further, if the content exceeds 5%, the weather resistance tends to be low. Accordingly, the content is at most 5%. It is preferably at most 4.5%, more preferably at most 4%.

By MgO, the melting property can be improved. However, if its content is less than 0.1%, no significant effect to improve the melting property may be obtained. Accordingly, it is preferably contained in a content of at least 0.1%. Its content is more preferably at least 0.2%, particularly preferably at least 0.5%. Further, if the content exceeds 15%, the weather resistance tends to be low. Accordingly, the content is at most 15%. It is preferably at most 14%, more preferably at most 12%.

By ZnO, the weather resistance can be improved. However, if its content is less than 0.1%, no significant effect to improve the weather resistance may be obtained. Accordingly, it is preferably contained in a content of at least 0.1%. Its content is more preferably at least 0.2%, particularly preferably at least 0.3%. Further, if the content exceeds 5%, the glass tends to be unstable. Accordingly, the content is at most 5%. It is preferably at most 4%, more preferably at most 3%.

By RO (wherein R is at least one member selected from Sr, Ba and Ca), the melting property can be improved. However, on the contrary, the chemical strengthening properties may be deteriorated, and accordingly its addition should be limited to the minimum amount required, and its content is preferably at most 1% in total, more preferably at most 0.5%.

By ZrO₂, the ion exchange rate can be increased. However, if its content is less than 0.01%, no significant effect to improve the ion exchange rate may be obtained. Accordingly, it is preferably contained in a content of at least 0.01%. Its content is more preferably at least 0.05%, particularly preferably at least 0.1%. Further, if the content exceeds 5%, the melting property tends to be low, whereby ZrO₂ may remain in the glass as an unmelted substance. Accordingly, its content is at most 5%. It is preferably at most 4%, more preferably at most 3%.

The glass for chemical strengthening according to this embodiment may further contain SO₃ as the case requires.

SO₃ is a component which functions as a clarifying agent. However, if its content is less than 0.01%, no desired clarifying effect may be obtained. Accordingly, in a case where SO₃ is contained, it is preferably contained in a content of at least 0.01%. Its content is more preferably at least 0.03%, particularly preferably at least 0.05%. However, if the content exceeds 1%, SO₃ may rather be a source of bubbles, whereby melting of the glass tends to be slow, or the number of bubbles may increase. Accordingly, the content is preferably at most 1%. It is more preferably at most 0.8%, particularly preferably at most 0.6%.

The glass for chemical strengthening according to this embodiment, particularly by containing Fe₂O₃ and TiO₂, has excellent solarization resistance and can have a compressive stress layer having sufficient depth and surface compressive stress formed on its surface by applying chemical strengthening treatment, whereby green chemically strengthened glass having high strength can be obtained.

The glass for chemical strengthening according to the third embodiment of the glass 1 for chemical strengthening of the present invention was described above. However, the glass for chemical strengthening according to a third embodiment of the glass 2 for chemical strengthening of the present invention is the same as the glass for chemical strengthening according to the third embodiment of the glass 1 for chemical strengthening except that the content of K₂O is from 0 to 15%. By incorporating K₂O, the melting property can be improved, and the ion exchange rate in chemical strengthening can be made high. However, if its content is less than 0.1%, no significant effect to improve the melting property may be obtained, or no significant effect to improve the ion exchange rate may be obtained. Accordingly, it is preferably contained in a content of at least 0.1%. Its content is more preferably at least 0.2%, particularly preferably at least 0.5%. Further, if the content exceeds 15%, cracking is likely to occur from an indentation when the glass surface has an indentation, whereby the glass strength tends to be low. Accordingly, the content is at most 15%. It is preferably at most 12%, more preferably at most 10%.

The method for producing the glass for chemical strengthening according to this embodiment is not particularly limited, and the glass for chemical strengthening is produced, for example, in such a manner that appropriate amounts of various raw materials are mixed, heated to about 1,500 to 1,600° C. and melted, homogenized by degassing, stirring or the like, and formed into a plate by a known down draw method, pressing method or the like or formed into a block by casting, and the plate or the block is annealed and cut into a desired size, followed by polishing as the case requires.

Further, the method of chemically strengthening the glass for chemical strengthening according to this embodiment is not particularly limited so long as Na₂O in the glass surface layer and K₂O in the molten salt can be ion exchanged, and for example, a method of dipping a glass plate or a glass formed product in a potassium nitrate (KNO₃) molten salt heated to from 400 to 550° C. for from 2 to 20 hours may be used.

Of the glass for chemical strengthening according to this embodiment, the transmittance deterioration degree ΔT obtained from the following formula is preferably at most 5%, more preferably at most 4%.

ΔT(%)=[(T0−T1)/T0]×100

wherein T1 is the average transmittance at wavelengths of from 380 nm to 780 nm in a spectral transmittance curve obtained after a polished surface of glass for chemical strengthening having a thickness of 2 mm having both surfaces optically mirror-polished, is irradiated with light of a 400 W high pressure mercury lamp with a distance of 15 cm for 50 hours, and T0 is the average transmittance at wavelengths of from 380 nm to 780 nm in a spectral transmittance curve before light irradiation.

### Fourth Embodiment

Now, the glass for chemical strengthening according to a fourth embodiment of the present invention will be described.

The glass for chemical strengthening according to a fourth embodiment is glass colored yellow, and for example, glass having a color tone which satisfies, as represented by the value (x,y) on the CIE chromaticity coordinate, 0.31≦x≦0.66 and 0.31≦y≦0.58 can be obtained.

The glass for chemical strengthening according to a fourth embodiment of the glass 1 for chemical strengthening of the present invention comprises SiO₂, Al₂O₃, Na₂O, Fe₂O₃, TiO₂, and as a coloring component at least one member selected from CeO₂, V₂O₅, Bi₂O₃ and Eu₂O₃ as essential components.

The composition of the glass for chemical strengthening according to the fourth embodiment is as follows.

SiO₂: 55 to 80%,

Al₂O₃: 3 to 16%,

Na₂O: 5 to 16%,

B₂O₃: 0 to 12%,

Fe₂O₃: 0.001 to 3%,

TiO₂: 0.001 to 3%,

CeO₂: 0 to 3%,

V₂O₅: 0 to 5%,

Bi₂O₃: 0 to 10%,

Eu₂O₃: 0 to 3%,

(CeO₂+V₂O₅+Bi₂O₃+Eu₂O₃): 0.01 to 10%,

B₂O₃: 0 to 12%,

K₂O: 0 to 5%,

MgO: 0 to 15%,

ZnO: 0 to 5%,

ZrO₂: 0 to 5%,

RO: 0 to 1% (wherein R is at least one member selected from Sr, Ba and Ca).

SiO₂ which is an essential component of the glass for chemical strengthening according to this embodiment is a component constituting a glass matrix. If its content is less than 55%, the stability as the glass tends to be low, or the weather resistance tends to be low. Accordingly, it is contained in a content of at least 55%. Its content is preferably at least 58%, more preferably at least 60%. Further, if the content exceeds 80%, the viscosity of the glass tends to increase, and the melting property tends to be low. Accordingly, the content is at most 80%. It is preferably at most 78%, more preferably at most 75%.

Al₂O₃ is a component to improve the weather resistance of the glass. If its content is less than 3%, the weather resistance tends to be low. Accordingly, it is contained in a content of at least 3%. Its content is preferably at least 4%, more preferably at least 5%. Further, if the content exceeds 16%, the viscosity of the glass tends to be high, whereby homogenous melting tends to be difficult. Accordingly, the content is at most 16%. It is preferably at most 14%, more preferably at most 12%.

Na₂O is a component to improve the melting property of the glass and is a component necessary to form a compressive stress layer on the glass surface by ion exchange. If its content is less than 5%, the melting property tends to be low, and it tends to be difficult to form a desired compressive stress layer on the glass surface by ion exchange. Accordingly, it is contained in a content of at least 5%. Its content is preferably at least 6%, more preferably at least 8%. Further, if the content exceeds 16%, the weather resistance tends to be low. Accordingly, the content is at most 16%. It is preferably at most 15%, more preferably at most 14%.

Fe₂O₃ is a component to facilitate movement of ions in the glass to promote ion exchange. If its content is less than 0.001%, no effect to promote ion exchange will be obtained. Accordingly, it is contained in a content of at least 0.001%. Its content is preferably at least 0.01%, more preferably at least 0.03%. Further, if the content exceeds 3%, the glass tends to be unstable, and is likely to be devitrified. Accordingly, the content is at most 3%. It is preferably at most 2.8%, more preferably at most 2.5%.

The reason why ion exchange is promoted by addition of Fe₂O₃ is considered that by presence of 4-coordinated Fe³⁺ in the glass, non-bridging oxygen in the glass is converted to bridging oxygen and as a result, a negative charge density is lowered, and Na⁺ ions are likely to be moved.

Fe₂O₃ makes the glass yellow or green depending upon the valency state of Fe ions. In the case of Fe²⁺, the glass will be green to bluish green, and in the case of Fe³⁺, the glass will be yellow. For promotion of chemical strengthening which is a great characteristic of the present invention, a state of Fe³⁺ is preferred, and it is preferably melted in an oxidizing condition, however, usually both Fe²⁺ and Fe³⁺ are present in the glass, and not all the iron ions can be in a Fe³⁺ state. The degree to color the glass yellow by Fe³⁺ is low, but Fe₂O₃ may be used in combination with the above-described yellow coloring agent.

TiO₂ is a component having an effect to increase the solarization resistance of the glass and an effect to increase coloring by other colored ions. If its content is less than 0.001%, the solarization resistance will not be improved. Accordingly, it is contained in a content of at least 0.001%. Its content is preferably at least 0.01%, more preferably at least 0.02%. Further, if the content exceeds 3%, the crystallization tendency of the glass will be increased, and devitrification tends to occur. Accordingly, the content is at most 3%. It is preferably at most 2.8%, more preferably at most 2.5%.

At least one member selected from CeO₂, V₂O₅, Bi₂O₃ and Eu₂O₃ contained as the coloring component is a component essential to color the glass yellow. If the content of the coloring component is less than 0.01%, no desired yellow glass will be obtained. Accordingly, the at least one member is contained in a content of at least 0.01%. The content is preferably at least 0.05%, more preferably at least 0.1%. Further, if the content exceeds 10%, the glass tends to be unstable. Accordingly, the content is at most 10%. It is preferably at most 8%, more preferably at most 6%.

However, if the content of CeO₂ exceeds 3%, the glass tends to be unstable. Accordingly, the content of CeO₂ is at most 3%. It is preferably at most 2.8%, more preferably at most 2.5%. The Ce ions make the glass yellow in a tetravalent state, and accordingly CeO₂ is preferably added in a tetravalent state and melted in an oxidizing condition. If the content of V₂O₅ exceeds 5%, the glass tends to be unstable. Accordingly, the content of V₂O₅ is at most 5%. It is preferably at most 4%, more preferably at most 3%. The V ions make the glass yellow in a pentavalent state, and accordingly V₂O₅ is preferably melted in an oxidizing condition. If the content of Bi₂O₃ exceeds 10%, a colloid of metal bismuth tends to be precipitated at the time of melting, whereby desired yellow glass will hardly be obtained. Accordingly, the content of Bi₂O₃ is at most 10%. It is preferably at most 8%, more preferably at most 5%. If the content of Eu₂O₃ exceeds 3%, the material cost tends to be high. Accordingly, the content of Eu₂O₃ is at most 3%. It is preferably at most 2.5%, more preferably at most 2%. In a case where Eu₂O₃ is used, it is preferably melted in a reducing condition.

In this embodiment, the glass may contain at least one member selected from a coloring component MpOq (wherein M is at least one member selected from Co, Cu, Cr, Pr, Mn, Er, Ni, Nd, W, Rb, Sn and Ag, and p and q represent the atomic ratio of M and O) other than the above coloring components, within a range not to impair coloring in yellow. In such a case, the total content with the above coloring components is preferably not higher than 10%. If the content exceeds 10%, the glass tends to be unstable. It is preferably at most 9%, more preferably at most 8%.

The glass for chemical strengthening according to this embodiment may contain, as the case requires, B₂O₃, K₂O, MgO, ZnO, RO (wherein R is at least one member selected from Sr, Ba and Ca) and ZrO₂.

By B₂O₃, the weather resistance can be improved. However, if its content is less than 0.1%, no significant effect to improve the weather resistance may be obtained. Accordingly, it is preferably contained in a content of at least 0.1%. Its content is more preferably at least 0.5%, particularly preferably at least 2%. Further, if the content exceeds 12%, striae may form by volatilization, thus lowering the yield. Accordingly, the content is at most 12%. It is preferably at most 10%, more preferably at most 8%.

By K₂O, the melting property can be improved, and the ion exchange rate in chemical strengthening can be made high. However, if its content is less than 0.1%, no significant effect to improve the melting property may be obtained, or no significant effect to improve the ion exchange rate may be obtained. Accordingly, it is preferably contained in a content of at least 0.1%. Its content is more preferably at least 0.2%, particularly preferably at least 0.5%. Further, if the content exceeds 5%, the weather resistance tends to be low. Accordingly, the content is at most 5%. It is preferably at most 4.5%, more preferably at most 4%.

By MgO, the melting property can be improved. However, if its content is less than 0.1%, no significant effect to improve the melting property may be obtained. Accordingly, it is preferably contained in a content of at least 0.1%. Its content is more preferably at least 0.2%, particularly preferably at least 0.5%. Further, if the content exceeds 15%, the weather resistance tends to be low. Accordingly, the content is at most 15%. It is preferably at most 14%, more preferably at most 12%.

By ZnO, the weather resistance can be improved. However, if its content is less than 0.1%, no significant effect to improve the weather resistance may be obtained. Accordingly, it is preferably contained in a content of at least 0.1%. Its content is more preferably at least 0.2%, particularly preferably at least 0.3%. Further, if the content exceeds 5%, the glass tends to be unstable. Accordingly, the content is at most 5%. It is preferably at most 4%, more preferably at most 3%.

By RO (wherein R is at least one member selected from Sr, Ba and Ca), the melting property can be improved. However, on the contrary, the chemical strengthening properties may be deteriorated, and accordingly its addition should be limited to the minimum amount required, and its content is preferably at most 1% in total, more preferably at most 0.5%.

By ZrO₂, the ion exchange rate can be increased. However, if its content is less than 0.01%, no significant effect to improve the ion exchange rate may be obtained. Accordingly, it is preferably contained in a content of at least 0.01%. Its content is more preferably at least 0.05%, particularly preferably at least 0.1%. Further, if the content exceeds 5%, the melting property tends to be low, whereby ZrO₂ may remain in the glass as an unmelted substance. Accordingly, its content is at most 5%. It is preferably at most 4%, more preferably at most 3%.

The glass for chemical strengthening according to this embodiment may further contain SO₃ as the case requires.

SO₃ is a component which functions as a clarifying agent. However, if its content is less than 0.01%, no desired clarifying effect may be obtained. Accordingly, in a case where SO₃ is contained, it is preferably contained in a content of at least 0.01%. Its content is more preferably at least 0.03%, particularly preferably at least 0.05%. However, if the content exceeds 1%, SO₃ may rather be a source of bubbles, whereby melting of the glass tends to be slow, or the number of bubbles may increase. Accordingly, the content is preferably at most 1%. It is more preferably at most 0.8%, particularly preferably at most 0.6%.

The glass for chemical strengthening according to this embodiment, particularly by containing Fe₂O₃ and TiO₂, has excellent solarization resistance and can have a compressive stress layer having sufficient depth and surface compressive stress formed on its surface by applying chemical strengthening treatment, whereby yellow chemically strengthened glass having high strength can be obtained.

The glass for chemical strengthening according to the fourth embodiment of the glass 1 for chemical strengthening of the present invention was described above. However, the glass for chemical strengthening according to a fourth embodiment of the glass 2 for chemical strengthening of the present invention is the same as the glass for chemical strengthening according to the fourth embodiment of the glass 1 for chemical strengthening except that the K₂O content is from 0 to 15%. By incorporating K₂O, the melting property can be improved, and the ion exchange rate in chemical strengthening can be made high. However, if its content is less than 0.1%, no significant effect to improve the melting property may be obtained, or no significant effect to improve the ion exchange rate may be obtained. Accordingly, it is preferably contained in a content of at least 0.1%. Its content is more preferably at least 0.2%, particularly preferably at least 0.5%. Further, if the content exceeds 15%, cracking is likely to occur from an indentation if the glass surface has an indentation, whereby the glass strength tends to be low. Accordingly, the content is at most 15%. It is preferably at most 12%, more preferably at most 10%.

The method for producing the glass for chemical strengthening according to this embodiment is not particularly limited, and the glass for chemical strengthening is produced, for example, in such a manner that appropriate amounts of various raw materials are mixed, heated to about 1,500 to 1,600° C. and melted, homogenized by degassing, stirring or the like, and formed into a plate by a known down draw method, pressing method or the like or formed into a block by casting, and the plate or the block is annealed and cut into a desired size, followed by polishing as the case requires.

Further, the method of chemically strengthening the glass for chemical strengthening according to this embodiment is not particularly limited so long as Na₂O in the glass surface layer and K₂O in the molten salt can be ion exchanged, and for example, a method of dipping a glass plate or a glass formed product in a potassium nitrate (KNO₃) molten salt heated to from 400 to 550° C. for from 2 to 20 hours may be used.

Of the glass for chemical strengthening according to this embodiment, the transmittance deterioration degree ΔT obtained from the following formula is preferably at most 5%, more preferably at most 4%.

ΔT(%)=[(T0−T1)/T0]×100

wherein T1 is the average transmittance at wavelengths of from 380 nm to 780 nm in a spectral transmittance curve obtained after a polished surface of glass for chemical strengthening having a thickness of 2 mm having both surfaces optically mirror-polished, is irradiated with light of a 400 W high pressure mercury lamp with a distance of 15 cm for 50 hours, and T0 is the average transmittance at wavelengths of from 380 nm to 780 nm in a spectral transmittance curve before light irradiation.

### Fifth Embodiment

The glass for chemical strengthening according to a fifth embodiment of the present invention will be described.

The glass for chemical strengthening according to a fifth embodiment is violet to pink glass, and for example, glass having a color tone which satisfies, as represented by the value (x,y) on the CIE chromaticity coordinate, 0.26≦x≦0.50 and 0.04≦y≦0.34, can be obtained.

The glass for chemical strengthening according to a fifth embodiment of the glass 1 for chemical strengthening of the present invention comprises SiO₂, Al₂O₃, Na₂O, Fe₂O₃, TiO₂ and as a coloring component at least one member selected from MnO₂, Er₂O₃, NiO, Nd₂O₃ and WO₃ as essential components.

The composition of the glass for chemical strengthening according to the fifth embodiment is as follows.

SiO₂: 55 to 80%,

Al₂O₃: 3 to 16%,

Na₂O: 5 to 16%,

B₂O₃: 0 to 12%,

Fe₂O₃: 0.001 to 3%,

TiO₂: 0.001 to 3%,

MnO₂: 0 to 10%,

Er₂O₃: 0 to 3%,

NiO: 0 to 5%,

Nd₂O₃: 0 to 3%,

WO₃: 0 to 10%,

(MnO₂+Er₂O₃+NiO+Nd₂O₃+WO₃): 0.01 to 10%,

B₂O₃: 0 to 12%,

K₂O: 0 to 5%,

MgO: 0 to 15%,

ZnO: 0 to 5%,

ZrO₂: 0 to 5%,

RO: 0 to 1% (wherein R is at least one member selected from Sr, Ba and Ca).

SiO₂ which is an essential component of the glass for chemical strengthening according to this embodiment is a component constituting a glass matrix. If its content is less than 55%, the stability as the glass tends to be low, or the weather resistance tends to be low. Accordingly, it is contained in a content of at least 55%. Its content is preferably at least 58%, more preferably at least 60%. Further, if the content exceeds 80%, the viscosity of the glass tends to increase, and the melting property tends to be low. Accordingly, the content is at most 80%. It is preferably at most 78%, more preferably at most 75%.

Al₂O₃ is a component to improve the weather resistance of the glass. If its content is less than 3%, the weather resistance tends to be low. Accordingly, it is contained in a content of at least 3%. Its content is preferably at least 4%, more preferably at least 5%. Further, if the content exceeds 16%, the viscosity of the glass tends to be high, whereby homogenous melting tends to be difficult. Accordingly, the content is at most 16%. It is preferably at most 14%, more preferably at most 12%.

Na₂O is a component to improve the melting property of the glass and is a component necessary to form a compressive stress layer on the glass surface by ion exchange. If its content is less than 5%, the melting property tends to be low, and it tends to be difficult to form a desired compressive stress layer on the glass surface by ion exchange. Accordingly, it is contained in a content of at least 5%. Its content is preferably at least 6%, more preferably at least 8%. Further, if the content exceeds 16%, the weather resistance tends to be low. Accordingly, the content is at most 16%. It is preferably at most 15%, more preferably at most 14%.

Fe₂O₃ is a component to facilitate movement of ions in the glass to promote ion exchange. If its content is less than 0.001%, no effect to promote ion exchange will be obtained. Accordingly, it is contained in a content of at least 0.001%. Its content is preferably at least 0.01%, more preferably at least 0.03%. Further, if the content exceeds 3%, the glass tends to be unstable, and is likely to be devitrified. Accordingly, the content is at most 3%. It is preferably at most 2.8%, more preferably at most 2.5%.

The reason why ion exchange is promoted by addition of Fe₂O₃ is considered that by presence of 4-coordinated Fe³⁺ in the glass, non-bridging oxygen in the glass is converted to bridging oxygen and as a result, a negative charge density is lowered, and Na⁺ ions are likely to be moved.

TiO₂ is a component having an effect to increase the solarization resistance of the glass and an effect to increase coloring by other colored ions. If its content is less than 0.001%, the solarization resistance will not be improved. Accordingly, it is contained in a content of at least 0.001%. Its content is preferably at least 0.01%, more preferably at least 0.02%. Further, if the content exceeds 3%, the crystallization tendency of the glass will be increased, and devitrification tends to occur. Accordingly, the content is at most 3%. It is preferably at most 2.8%, more preferably at most 2.5%.

At least one member selected from MnO₂, Er₂O₃, NiO, Nd₂O₃ and WO₃ contained as the coloring component is a component essential to color the glass violet to pink. If the content of the coloring component is less than 0.01%, no desired violet to pink glass will be obtained. Accordingly, the at least one member is contained in a content of at least 0.01%. The content is preferably at least 0.05%, more preferably at least 0.1%. Further, if the content exceeds 10%, the color tends to be too deep. Accordingly, the content is at most 10%. It is preferably at most 8%, more preferably at most 6%.

However, if the content of MnO₂ exceeds 10%, the color tends to be too deep. Accordingly, the content of MnO₂ is at most 10%. It is preferably at most 8%, more preferably at most 6%. If the content of Er₂O₃ exceeds 3%, the material cost tends to be too high. Accordingly, the content of Er₂O₃ is at most 3%. It is preferably at most 2.8%, more preferably at most 2.5%. If the content of NiO exceeds 5%, the color tends to be too deep. Accordingly, the content of NiO is at most 5%. It is preferably at most 4%, more preferably at most 3%. If the content of Nd₂O₃ exceeds 3%, the material cost tends to be high. Accordingly, the content of Nd₂O₃ is at most 3%. It is preferably at most 2.8%, more preferably at most 2.5%. If the content of WO₃ exceeds 10%, the glass tends to be unstable. Accordingly, the content of WO₃ is at most 10%. It is preferably at most 8%, more preferably at most 5%.

In this embodiment, the glass may contain at least one member selected from a coloring component MpOq (wherein M is at least one member selected from Co, Cu, V, Cr, Pr, Ce, Bi, Eu, Rb, Sn and Ag, and p and q represent the atomic ratio of M and O) other than the above coloring components, within a range not to impair coloring in violet to pink. In such a case, the total content with the above coloring components is preferably not higher than 10%. If the content exceeds 10%, the glass tends to be unstable. It is preferably at most 9%, more preferably at most 8%.

The glass for chemical strengthening according to this embodiment may contain B₂O₃, K₂O, MgO, ZnO, RO (wherein R is at least one member selected from Sr, Ba and Ca) and ZrO₂ as the case requires.

By B₂O₃, the weather resistance can be improved. However, if its content is less than 0.1%, no significant effect to improve the weather resistance may be obtained. Accordingly, it is preferably contained in a content of at least 0.1%. Its content is more preferably at least 0.5%, particularly preferably at least 2%. Further, if the content exceeds 12%, striae may form by volatilization, thus lowering the yield. Accordingly, the content is at most 12%. It is preferably at most 10%, more preferably at most 8%.

By K₂O, the melting property can be improved, and the ion exchange rate in chemical strengthening can be made high. However, if its content is less than 0.1%, no significant effect to improve the melting property may be obtained, or no significant effect to improve the ion exchange rate may be obtained. Accordingly, it is preferably contained in a content of at least 0.1%. Its content is more preferably at least 0.2%, particularly preferably at least 0.5%. Further, if the content exceeds 5%, the weather resistance tends to be low. Accordingly, the content is at most 5%. It is preferably at most 4.5%, more preferably at most 4%.

By MgO, the melting property can be improved. However, if its content is less than 0.1%, no significant effect to improve the melting property may be obtained. Accordingly, it is preferably contained in a content of at least 0.1%. Its content is more preferably at least 0.2%, particularly preferably at least 0.5%. Further, if the content exceeds 15%, the weather resistance tends to be low. Accordingly, the content is at most 15%. It is preferably at most 14%, more preferably at most 12%.

By ZnO, the weather resistance can be improved. However, if its content is less than 0.1%, no significant effect to improve the weather resistance may be obtained. Accordingly, it is preferably contained in a content of at least 0.1%. Its content is preferably at least 0.2%, particularly preferably at least 0.3%. Further, if the content exceeds 5%, the glass tends to be unstable. Accordingly, the content is at most 5%. It is preferably at most 4%, more preferably at most 3%.

By RO (wherein R is at least one member selected from Sr, Ba and Ca), the melting property can be improved. However, on the contrary, the chemical strengthening properties may be deteriorated, and accordingly its addition should be limited to the minimum amount required, and its content is preferably at most 1% in total, more preferably at most 0.5%.

By ZrO₂, the ion exchange rate can be increased. However, if its content is less than 0.01%, no significant effect to improve the ion exchange rate may be obtained. Accordingly, it is preferably contained in a content of at least 0.01%. Its content is more preferably at least 0.05%, particularly preferably at least 0.1%. Further, if the content exceeds 5%, the melting property tends to be low, whereby ZrO₂ may remain in the glass as an unmelted substance. Accordingly, its content is at most 5%. It is preferably at most 4%, more preferably at most 3%.

The glass for chemical strengthening according to this embodiment may further contain SO₃ as the case requires.

SO₃ is a component which functions as a clarifying agent. However, if its content is less than 0.01%, no desired clarifying effect may be obtained. Accordingly, in a case where SO₃ is contained, it is preferably contained in a content of at least 0.01%. Its content is more preferably at least 0.03%, particularly preferably at least 0.05%. However, if the content exceeds 1%, SO₃ may rather be a source of bubbles, whereby melting of the glass tends to be slow, or the number of bubbles may increase. Accordingly, the content is preferably at most 1%. It is more preferably at most 0.8%, particularly preferably at most 0.6%.

The glass for chemical strengthening according to this embodiment, particularly by containing Fe₂O₃ and TiO₂, has excellent solarization resistance and can form a compressive stress layer having sufficient depth and surface compressive stress formed on its surface by applying chemical strengthening treatment, whereby violet to pink chemically strengthened glass having high strength can be obtained.

The glass for chemical strengthening according to the fifth embodiment of the glass 1 for chemical strengthening of the present invention was described above.

However, the glass for chemical strengthening according to a fifth embodiment of the glass 2 for chemical strengthening of the present invention is the same as the glass for chemical strengthening according to the fifth embodiment of the glass 1 for chemical strengthening except that the K₂O content is from 0 to 15%. By incorporating K₂O, the melting property can be improved, and the ion exchange rate in chemical strengthening can be made high. However, if its content is less than 0.1%, no significant effect to improve the melting property may be obtained, or no significant effect to improve the ion exchange rate may be obtained. Accordingly, it is preferably contained in a content of at feast 0.1%. Its content is more preferably at least 0.2%, particularly preferably at least 0.5%. Further, if the content exceeds 15%, cracking is likely to occur from an indentation if the glass surface has an indentation, whereby the glass strength tends to be low. Accordingly, the content is at most 15%. It is preferably at most 12%, more preferably at most 10%.

The method for producing the glass for chemical strengthening according to this embodiment is not particularly limited, and the glass for chemical strengthening is produced, for example, in such a manner that appropriate amounts of various raw materials are mixed, heated to about 1,500 to 1,600° C. and melted, homogenized by degassing, stirring or the like, and formed into a plate by a known down draw method, pressing method or the like or formed into a block by casting, and the plate or the block is annealed and cut into a desired size, followed by polishing as the case requires.

Further, the method of chemically strengthening the glass for chemical strengthening according to this embodiment is not particularly limited so long as Na₂O in the glass surface layer and K₂O in the molten salt can be ion exchanged, and for example, a method of dipping a glass plate or a glass formed product in a potassium nitrate (KNO₃) molten salt heated to from 400 to 550° C. for from 2 to 20 hours may be used.

Of the glass for chemical strengthening according to this embodiment, the transmittance deterioration degree ΔT obtained from the following formula is preferably at most 5%, more preferably at most 4%.

ΔT(%)=[(T0−T1)/T0]×100

wherein T1 is the average transmittance at wavelengths of from 380 nm to 780 nm in a spectral transmittance curve obtained after a polished surface of glass for chemical strengthening having a thickness of 2 mm having both surfaces optically mirror-polished, is irradiated with light of a 400 W high pressure mercury lamp with a distance of 15 cm for 50 hours, and T0 is the average transmittance at wavelengths of from 380 nm to 780 nm in a spectral transmittance curve before light irradiation.

### Sixth Embodiment

Now, glass for chemical strengthening according to a sixth embodiment of the present invention will be described.

The glass for chemical strengthening according to a sixth embodiment is glass colored red, and for example, glass having a color tone which satisfies, as represented by the value (x,y) on the CIE chromaticity coordinate, 0.31≦x≦0.73 and 0.20≦y≦0.35, can be obtained. The glass for chemical strengthening according to a sixth embodiment of the present invention is glass colored red by precipitation of a colloid, and the above color tone is for glass colored red by applying heat treatment under desired conditions.

The glass for chemical strengthening according to a sixth embodiment of the glass 1 for chemical strengthening of the present invention comprises SiO₂, Al₂O₃, Na₂O, Fe₂O₃ and TiO₂ as essential components and further contains as a coloring component Cu₂O and/or Ag₂O (i.e. at least one member selected from the group consisting of Cu₂O and Ag₂O), and SnO and/or Sb₂O₃ (i.e. at least one member selected from the group consisting of SnO and Sb₂O₃) as essential components.

The composition of the glass for chemical strengthening according to the sixth embodiment is as follows:

SiO₂: 55 to 80%,

Al₂O₃: 3 to 16%,

Na₂O: 5 to 16%,

B₂O₃: 0 to 12%,

Fe₂O₃: 0.001 to 3%,

TiO₂: 0.001 to 3%,

Cu₂O: 0 to 3%,

Ag₂O: 0 to 6%,

(Cu₂O+Ag₂O): 0.01 to 6%,

SnO: 0 to 3%,

Sb₂O₃: 0 to 5%,

(SnO+Sb₂O₃): 0.01 to 5%,

B₂O₃: 0 to 12%,

K₂O: 0 to 5%,

MgO: 0 to 15%,

ZnO: 0 to 5%,

ZrO₂: 0 to 5%,

RO: 0 to 1% (wherein R is at least one member selected from Sr, Ba and Ca).

SiO₂ which is an essential component of the glass for chemical strengthening according to this embodiment is a component constituting a glass matrix. If its content is less than 55%, the stability as the glass tends to be low, or the weather resistance tends to be low. Accordingly, it is contained in a content of at least 55%. Its content is preferably at least 58%, more preferably at least 60%. Further, if the content exceeds 80%, the viscosity of the glass tends to increase, and the melting property tends to be low. Accordingly, the content is at most 80%. It is preferably at most 78%, more preferably at most 75%.

Al₂O₃ is a component to improve the weather resistance of the glass. If its content is less than 3%, the weather resistance tends to be low. Accordingly, it is contained in a content of at least 3%. Its content is preferably at least 4%, more preferably at least 5%. Further, if the content exceeds 16%, the viscosity of the glass tends to be high, whereby homogenous melting tends to be difficult. Accordingly, the content is at most 16%. It is preferably at most 14%, more preferably at most 12%.

Na₂O is a component to improve the melting property of the glass and is a component to form a compressive stress layer on the glass surface by ion exchange. If its content is less than 5%, the melting property tends to be low, and it tends to be difficult to form a desired compressive stress layer on the glass surface by ion exchange. Accordingly, it is contained in a content of at least 5%. Its content is preferably at least 6%, more preferably at least 8%. Further, if the content exceeds 16%, the weather resistance tends to be low. Accordingly, the content is at most 16%. It is preferably at most 15%, more preferably at most 14%.

Fe₂O₃ is a component to facilitate movement of ions in the glass to promote ion exchange. If its content is less than 0.001%, no effect to promote ion exchange will be obtained. Accordingly, it is contained in a content of at least 0.001%. Its content is at least 0.01%, more preferably at least 0.03%. Further, if the content exceeds 3%, the glass tends to be unstable, and is likely to be devitrified. Accordingly, the content is at most 3%. It is preferably at most 2.8%, more preferably at most 2.5%.

The reason why ion exchange is promoted by addition of Fe₂O₃ is considered that by presence of 4-coordinated Fe³⁺ in the glass, non-bridging oxygen in the glass is converted to bridging oxygen and as a result, a negative charge density is lowered, and Na⁺ ions are likely to be moved.

TiO₂ is a component having an effect to increase the solarization resistance of the glass and an effect to increase coloring by other colored ions. If its content is less than 0.001%, the solarization resistance will not be improved. Accordingly, it is contained in a content of at least 0.001%. Its content is preferably at least 0.01%, more preferably at least 0.02%. Further, if the content exceeds 3%, the crystallization tendency of the glass will be increased, and devitrification tends to occur. Accordingly, the content is at most 3%. It is preferably at most 2.8%, more preferably at most 2.5%.

The coloring component Cu₂O and/or Ag₂O is a component essential to color the glass red. If the content of the coloring component is less than 0.001%, no desired red glass will be obtained. Accordingly, the coloring component is contained in a content of at least 0.001%. Its content is preferably at least 0.1%, more preferably at least 0.2%. Further, if the content exceeds 6%, the glass tends to be unstable. Accordingly, the content is at most 6%. It is preferably at most 5%, more preferably at most 4%.

However, if the content of Cu₂O exceed 3%, no stable coloring will be obtained. Accordingly, the content of Cu₂O is at most 3%. It is preferably at most 2.8%, more preferably at most 2.5%. If the content of Ag₂O exceeds 6%, the glass tends to be unstable. Accordingly, the content of Ag₂O is at most 6%. It is preferably at most 5%, more preferably at most 4%.

SnO and/or Sb₂O₃ is a component which functions as a so-called heat reducing agent which reduces the coloring component Cu₂O or Ag₂O to precipitate a Cu or Ag colloid in the subsequent heat treatment. If the total content of both is less than 0.01%, no desired effect as a heat reducing agent may be obtained. Accordingly, the total content of both is preferably at least 0.01%. It is more preferably at least 0.1%, particularly preferably at least 0.3%. Further, if the content exceeds 5%, the glass tends to be unstable and is likely to be devitrified. Accordingly, the content is preferably at most 5%. It is more preferably at most 4%, particularly preferably at most 3%_{.}

However, if the content of SnO is less than 0.05%, no desired effect as a heat reducing agent may be obtained. Accordingly, in a case where SnO is contained, it is preferably contained in a content of at least 0.05%. The content is preferably at least 0.1%, particularly preferably at least 0.2%. Further, if the content exceeds 3%, the glass tends to be unstable and is likely to be devitrified. Accordingly, the content is preferably at most 3%. It is more preferably at most 2.8%, particularly preferably at most 2.5%.

Further, if the content of Sb₂O₃ is less than 0.05%, no desired effect as a heat reducing agent may be obtained. Accordingly, in a case where Sb₂O₃ is contained, it is preferably contained in a content of at least 0.05%. The content is preferably at least 0.1%, particularly preferably at least 0.2%. Further, if the content exceeds 5%, the glass tends to be unstable and is likely to be devitrified. Accordingly, the content is preferably at most 5%. It is more preferably at most 3%, particularly preferably at most 1%. Here, since Sb₂O₃ is a substance of concern, it is preferred to use SnO as the heat reducing agent.

In this embodiment, the glass may contain at least one member selected from a coloring component MpOq (wherein M is at least one member selected from Co, V, Cr, Pr, Ce, Bi, Eu, Mn, Er, Ni, Nd, Rb and W, and p and q represent the atomic ratio of M and O) other than the above coloring components within a range not to impair coloring in red. In such a case, the total content with the above coloring components is preferably not higher than 10%. If the content exceeds 10%, the glass tends to be unstable. The content is preferably at most 9%, more preferably at most 8%.

The glass for chemical strengthening according to this embodiment may contain, as the case requires, B₂O₃, K₂O, MgO, ZnO, RO (wherein R is at least one member selected from Sr, Ba and Ca) and ZrO₂.

By B₂O₃, the weather resistance can be improved. However, if its content is less than 0.1%, no significant effect to improve the weather resistance may be obtained. Accordingly, it is preferably contained in a content of at least 0.1%. Its content is more preferably at least 0.5%, particularly preferably at least 2%. Further, if the content exceeds 12%, striae may form by volatilization, thus lowering the yield. Accordingly, the content is at most 12%. It is preferably at most 10%, more preferably at most 8%.

By K₂O, the melting property can be improved, and the ion exchange rate in chemical strengthening can be made high. However, if its content is less than 0.1%, no significant effect to improve the melting property may be obtained, or no significant effect to improve the ion exchange rate may be obtained. Accordingly, it is preferably contained in a content of at least 0.1%. Its content is more preferably at least 0.2%, particularly preferably at least 0.5%. Further, if the content exceeds 5%, the weather resistance tends to be low. Accordingly, the content is at most 5%. It is preferably at most 4.5%, more preferably at most 4%.

By MgO, the melting property can be improved. However, if its content is less than 0.1%, no significant effect to improve the melting property may be obtained. Accordingly, it is preferably contained in a content of at least 0.1%. Its content is more preferably at least 0.2%, particularly preferably at least 0.5%. Further, if the content exceeds 15%, the weather resistance tends to be low. Accordingly, the content is at most 15%. It is preferably at most 14%, more preferably at most 12%.

By ZnO, the weather resistance can be improved. However, if its content is less than 0.1%, no significant effect to improve the weather resistance may be obtained. Accordingly, it is preferably contained in a content of at least 0.1%. Its content is more preferably at least 0.2%, particularly preferably at least 0.3%. Further, if the content exceeds 5%, the glass tends to be unstable. Accordingly, the content is at most 5%. It is preferably at most 4%, more preferably at most 3%.

By RO (wherein R is at least one member selected from Sr, Ba and Ca), the melting property can be improved. However, on the contrary, the chemical strengthening properties may be deteriorated, and accordingly its addition should be limited to the minimum amount required, and its content is preferably at most 1% in total, more preferably at most 0.5%.

By ZrO₂, the ion exchange rate can be increased. However, if its content is less than 0.01%, no significant effect to improve the ion exchange rate may be obtained. Accordingly, it is preferably contained in a content of at least 0.01%. Its content is more preferably at least 0.05%, particularly preferably at least 0.1%. Further, if the content exceeds 5%, the melting property tends to be low, whereby ZrO₂ may remain in the glass as an unmelted substance. Accordingly, its content is at most 5%. It is preferably at most 4%, more preferably at most 3%.

The glass for chemical strengthening according to this embodiment may further contain SO₃ as the case requires.

SO₃ is a component which functions as a clarifying agent. However, if its content is less than 0.01%, no desired clarifying effect may be obtained. Accordingly, in a case where SO₃ is contained, it is preferably contained in a content of at least 0.01% Its content is more preferably at least 0.03%, particularly preferably at least 0.05%. However, if the content exceeds 1%, SO₃ may rather be a source of bubbles, whereby melting of the glass tends to be slow, or the number of bubbles may increase. Accordingly, the content is preferably at most 1%. It is more preferably at most 0.8%, particularly preferably at most 0.6%.

The glass for chemical strengthening according to this embodiment, particularly by containing Fe₂O₃ and TiO₂, can have excellent solarization resistance and can have a surface compressive layer having sufficient depth and surface compressive stress formed on its surface by applying chemical strengthening treatment, whereby red chemically strengthened glass having high strength can be obtained.

The glass for chemical strengthening according to the sixth embodiment of the glass 1 for chemical strengthening of the present invention was described above. However, the glass for chemical strengthening according to a sixth embodiment of the glass 2 for chemical strengthening of the present invention is the same as the glass for chemical strengthening according to the sixth embodiment of the glass 1 for chemical strengthening except that the K₂O content is from 0 to 15%. By incorporating K₂O, the melting property can be improved, and the ion exchange rate in chemical strengthening can be made high. However, if its content is less than 0.1%, no significant effect to improve the melting property may be obtained, or no significant effect to improve the ion exchange rate may be obtained. Accordingly, it is preferably contained in a content of at least 0.1%. Its content is more preferably at least 0.2%, particularly preferably at least 0.5%. Further, if the content exceeds 15%, cracking is likely to occur from an indentation if the glass surface has an indentation, whereby the glass strength tends to be low. Accordingly, the content is at most 15%. It is preferably at most 12%, more preferably at most 10%.

The method for producing the glass for chemical strengthening according to this embodiment is not particularly limited, and the glass for chemical strengthening is produced, for example, in such a manner that appropriate amounts of various raw materials are mixed, heated to about 1,500 to 1,600° C. and melted, homogenized by degassing, stirring or the like, and formed into a plate by a known down draw method, pressing method or the like or formed into a block by casting, and the plate or the block is annealed and cut into a desired size, followed by polishing as the case requires.

Further, the method of chemically strengthening the glass for chemical strengthening according to this embodiment is not particularly limited so long as Na₂O in the glass surface layer and K₂O in the molten salt can be ion exchanged, and for example, a method of dipping a glass plate or a glass formed product in a potassium nitrate (KNO₃) molten salt heated to from 400 to 550° C. for from 2 to 20 hours may be used.

Of the glass for chemical strengthening according to this embodiment, the transmittance deterioration degree ΔT obtained from the following formula is preferably at most 5%, more preferably at most 4%.

ΔT(%)=[(T0−T1)/T0]×100

wherein T1 is the average transmittance at wavelengths of from 380 nm to 780 nm in a spectral transmittance curve obtained after a polished surface of glass for chemical strengthening having a thickness of 2 mm having both surfaces optically mirror-polished, is irradiated with light of a 400 W high pressure mercury lamp with a distance of 15 cm for 50 hours, and T0 is the average transmittance at wavelengths of from 380 nm to 780 nm in a spectral transmittance curve before light irradiation.

### Seventh Embodiment

Now, glass for chemical strengthening according to an embodiment of the glass 3 for chemical strengthening of the present invention will be described as a seventh embodiment.

The glass for chemical strengthening according to a seventh embodiment comprises SiO₂, Na₂O, CaO, Fe₂O₃, TiO₂ and a coloring component MpOq (wherein M is at least one member selected from Co, Cu, V, Cr, Pr, Ce, Bi, Eu, Mn, Er, Ni, Nd, W, Rb, Sn and Ag, and p and q represent the atomic ratio of M and O) as essential components.

The composition of the glass for chemical strengthening according to the seventh embodiment is as follows:

SiO₂: 55 to 80%,

Na₂O: 5 to 20%,

CaO: 1 to 15%,

Fe₂O₃: 0.001 to 3%,

TiO₂: 0.001 to 3%,

MpOq: 0.001 to 10% (wherein M is at least one member selected from Co, Cu, V, Cr, Pr, Ce, Bi, Eu, Mn, Er, Ni, Nd, W, Rb, Sn and Ag, and p and q represent the atomic ratio of M and O),

Al₂O₃: 0 to 5%,

B₂O₃: 0 to 12%,

K₂O: 0 to 8%,

ZnO: 0 to 5%,

ZrO₂: 0 to 5%,

RO: 0 to 10% (wherein R is at least one member selected from Sr, Ba and Mg).

SiO₂ which is an essential component of the glass for chemical strengthening according to this embodiment is a component constituting a glass matrix. If its content is less than 55%, the stability as the glass tends to be low, or the weather resistance tends to be low. Accordingly, it is contained in a content of at least 55%. Its content is preferably at least 58%, more preferably at least 60%. Further, if the content exceeds 80%, the viscosity of the glass tends to increase, and the melting property tends to be low. Accordingly, the content is at most 80%. It is preferably at most 78%, more preferably at most 75%.

Na₂O is a component to improve the melting property of the glass and is a component necessary to form a compressive stress layer on the glass surface by ion exchange. If its content is less than 5%, the melting property tends to be low, and it tends to be difficult to form a desired compressive stress layer on the glass surface by ion exchange. Accordingly, it is contained in a content of at least 5%. Its content is preferably at least 6%, more preferably at least 8%. Further, if the content exceeds 20%, the weather resistance tends to be low. Accordingly, the content is at most 20%. It is preferably at most 18%, more preferably at most 16%.

Fe₂O₃ is a component to facilitate movement of ions in the glass to promote ion exchange. If its content is less than 0.001%, no effect to promote ion exchange will be obtained. Accordingly, it is contained in a content of at least 0.001%. Its content is preferably at least 0.01%, more preferably at least 0.03%. Further, if the content exceeds 3%, the glass tends to be unstable, and is likely to be devitrified. Accordingly, the content is at most 3%. It is preferably at most 2.8%, more preferably at most 2.5%.

The reason why ion exchange is promoted by addition of Fe₂O₃ is considered that by presence of 4-coordinated Fe³⁺ in the glass, non-bridging oxygen in the glass is converted to bridging oxygen and as a result, a negative charge density is lowered, and Na⁺ ions are likely to be moved.

Fe₂O₃ makes the glass yellow or green depending upon the valency state of Fe ions. In the case of Fe²⁺, the glass will be green to bluish green, and in the case of Fe³⁺, the glass will be yellow. For promotion of chemical strengthening which is a great characteristic of the present invention, a state of Fe³⁺ is preferred, and it is preferably melted in an oxidizing condition, however, usually both Fe²⁺ and Fe³⁺ are present in the glass, and not all the iron ions can be in a Fe³⁺ state. Accordingly, in a case where the Fe₂O₃ content is high, Fe²⁺ which is present in a small amount may color the glass, and in such a case, the glass will be colored green, and accordingly it is possible to use Fe₂O₃ in combination with the above-described green coloring agent. The degree to color the glass yellow by Fe³⁺ is low, but in the same way of thinking, Fe₂O₃ may be used in combination with the above-described yellow coloring agent.

TiO₂ is a component having an effect to increase the solarization resistance of the glass and an effect to increase coloring by other colored ions. If its content is less than 0.001%, the solarization resistance will not be improved. Accordingly, it is contained in a content of at least 0.001%. Its content is preferably at least 0.01%, more preferably at least 0.02%. Further, if the content exceeds 3%, the crystallization tendency of the glass will be increased, and devitrification tends to occur. Accordingly, the content is at most 3%. It is preferably at most 2.8%, more preferably at most 2.5%.

The coloring component MpOq (wherein M is at least one member selected from Co, Cu, V, Cr, Pr, Ce, Bi, Eu, Mn, Er, Ni, Nd, W, Rb, Sn and Ag, and p and q represent the atomic ratio of M and O) is a component to color the glass in a desired color, and by properly selecting the coloring component for the glass for chemical strengthening according to the seventh embodiment, it is possible to obtain colored glass, for example, blue, green, yellow, violet to pink, or red glass.

Specifically, for example, by use of at least one member selected from Co₃O₄ and CuO, blue glass can be obtained. By use of at least one member selected from V₂O₅, Cr₂O₃, CuO and Pr₆O₁₁, green glass can be obtained. By use of at least one member selected from CeO₂, V₂O₅, Bi₂O₃ and Eu₂O₃, yellow glass can be obtained. By use of at least one member selected from MnO₂, Er₂O₃, NiO, Nd₂O₃ and WO₃, violet to pink glass can be obtained. By use of at least one member selected from Cu₂O and Ag₂O, red glass can be obtained.

If the content of the coloring component MpOq is less than 0.001%, coloring of the glass tends to be very thin, and accordingly the glass will not be recognized as colored unless it is very thick, and it is necessary to design the glass rather thick so that an obtainable colored housing has a design property. Accordingly, MpOq is contained in a content of at least 0.001%. Its content is preferably at least 0.05%, more preferably at least 0.1%. Further, if the content exceeds 10%, the glass tends to be unstable. Accordingly, the content is at most 10%. It is preferably at most 8%, more preferably at most 5%.

By CaO, the melting property can be improved. However, if its content is less than 1%, no significant effect to improve the melting property may be obtained. Accordingly, it is preferably contained in a content of at least 1%. Its content is more preferably at least 3%, particularly preferably at least 4%. Further, if the content exceeds 15%, the weather resistance tends to be low. Accordingly, the content is at most 15%. It is preferably at most 14%, more preferably at most 12%.

The glass for chemical strengthening according to this embodiment may contain Al₂O₃, B₂O₃, K₂O, ZnO, RO (wherein R is at least one member selected from Sr, Ba and Mg) and ZrO₂ as the case requires.

By Al₂O₃, the weather resistance can be improved. However, if its content is less than 0.1%, no significant effect to improve the weather resistance may be obtained. Accordingly, it is preferably contained in a content of at least 0.1%. Its content is preferably at least 0.5%, more preferably at least 0.8%. Further, if the content exceeds 5%, the viscosity of the glass tends to be high, and homogeneous melting tends to be difficult. Accordingly, the content is at most 5%. It is preferably at most 4%, more preferably at most 3%.

By B₂O₃, the weather resistance can be improved. However, if its content is less than 0.1%, no significant effect to improve the weather resistance may be obtained. Accordingly, it is preferably contained in a content of at least 0.1%. Its content is more preferably at least 0.5%, particularly preferably at least 2%. Further, if the content exceeds 12%, striae may form by volatilization, thus lowering the yield. Accordingly, the content is at most 12%. It is preferably at most 10%, more preferably at most 8%.

By K₂O, the melting property can be improved, and the ion exchange rate in chemical strengthening can be made high. However, if its content is less than 0.1%, no significant effect to improve the melting property may be obtained, or no significant effect to improve the ion exchange rate may be obtained. Accordingly, it is preferably contained in a content of at least 0.1%. Its content is more preferably at least 0.2%, particularly preferably at least 0.5%. Further, if the content exceeds 8%, the weather resistance tends to be low. Accordingly, the content is at most 8%. It is preferably at most 6%, more preferably at most 4%.

By ZnO, the weather resistance can be improved. However, if its content is less than 0.1%, no significant effect to improve the weather resistance may be obtained. Accordingly, it is preferably contained in a content of at least 0.1%. Its content is more preferably at least 0.2%, particularly preferably at least 0.3%. Further, if the content exceeds 5%, the glass tends to be unstable. Accordingly, the content is at most 5%. It is preferably at most 4%, more preferably at most 3%.

By RO (wherein R is at least one member selected from Sr, Ba and Mg), the melting property can be improved. However, on the contrary, the chemical strengthening properties may be deteriorated, and accordingly its addition should be limited to the minimum amount required, and its content is preferably at most 1% in total, more preferably at most 0.5%.

By ZrO₂, the ion exchange rate can be increased. However, if its content is less than 0.01%, no significant effect to improve the ion exchange rate may be obtained. Accordingly, it is preferably contained in a content of at least 0.01%. Its content is more preferably at least 0.05%, particularly preferably at least 0.1%. Further, if the content exceeds 5%, the melting property tends to be low, whereby ZrO₂ may remain in the glass as an unmelted substance. Accordingly, its content is at most 5%. It is preferably at most 4%, more preferably at most 3%.

The glass for chemical strengthening according to this embodiment may further contain SO₃, SnO or Sb₂O₃ as the case requires.

SO₃ is a component which functions as a clarifying agent. However, if its content is less than 0.01%, no desired clarifying effect may be obtained. Accordingly, in a case where SO₃ is contained, it is preferably contained in a content of at least 0.01%. Its content is more preferably at least 0.03%, particularly preferably at least 0.05%. However, if the content exceeds 1%, SO₃ may rather be a source of bubbles, whereby melting of the glass tends to be slow, or the number of bubbles may increase. Accordingly, the content is preferably at most 1%. It is more preferably at most 0.8%, particularly preferably at most 0.6%.

SnO functions, in a case where the glass is to be colored red, as a so-called heat reducing agent which reduces Cu₂O or Ag₂O to precipitate Cu or Ag colloid in the subsequent heat treatment. However, if its content is less than 0.05%, no desired effect as a heat reducing agent may be obtained. Accordingly, in a case where SnO is contained, it is preferably contained in a content of at least 0.05%. Its content is more preferably at least 0.1%, particularly preferably at least 0.2%. Further, if the content exceeds 3%, the glass tends to be unstable, and is likely to be devitrified. Accordingly, the content is preferably at most 3%. It is more preferably at most 2.8%, particularly preferably at most 2.5%.

Sb₂O₃ has a function, in a case where the glass is to be colored red, as a heat reducing agent like SnO. However, if its content is less than 0.05%, no desired effect as a heat reducing agent may be obtained. Accordingly, in a case where Sb₂O₃ is contained, it is preferably contained in a content of at least 0.05%. Its content is more preferably at least 0.1%, particularly preferably at least 0.2%. Further, if the content exceeds 5%, the glass tends to be unstable and is likely to be devitrified. Accordingly, the content is preferably at most 5%. It is more preferably at most 3%, particularly preferably at most 1%.

Since Sb₂O₃ is a substance of concern, it is preferred to use SnO as a heat reducing agent.

The glass for chemical strengthening according to this embodiment, particularly by containing Fe₂O₃ and TiO₂, has excellent solarization resistance and can have a compressive stress layer having sufficient depth and surface compressive stress formed on its surface by applying chemical strengthening treatment, whereby colored chemically strengthened glass having high strength can be obtained. The obtained chemically strengthened glass is useful as a material of a glass housing to accommodate an electronic device.

The method for producing the glass for chemical strengthening according to this embodiment is not particularly limited, and the glass for chemical strengthening is produced, for example, in such a manner that appropriate amounts of various raw materials are mixed, heated to about 1,500 to 1,600° C. and melted, homogenized by degassing, stirring or the like, and formed into a plate by a known down draw method, pressing method or the like or formed into a block by casting, and the plate or the block is annealed and cut into a desired size, followed by polishing as the case requires.

Further, the method of chemically strengthening the glass for chemical strengthening according to this embodiment is not particularly limited so long as Na₂O in the glass surface layer and K₂O in the molten salt can be ion exchanged, and for example, a method of dipping a glass plate or a glass formed product in a potassium nitrate (KNO₃) molten salt heated to from 400 to 550° C. for from 2 to 20 hours may be used.

Of the glass for chemical strengthening according to this embodiment, the transmittance deterioration degree ΔT obtained from the following formula is preferably at most 5%, more preferably at most 4%.

ΔT(%)=[(T0−T1)/T0]×100

wherein T1 is the average transmittance at wavelengths of from 380 nm to 780 nm in a spectral transmittance curve obtained after a polished surface of glass for chemical strengthening having a thickness of 2 mm having both surfaces optically mirror-polished, is irradiated with light of a 400 W high pressure mercury lamp with a distance of 15 cm for 50 hours, and T0 is the average transmittance at wavelengths of from 380 nm to 780 nm in a spectral transmittance curve before light irradiation.

This transmittance deterioration degree is an index to evaluate the solarization resistance of the glass for chemical strengthening.

### (Glass Housing)

Now, the glass housing of the present invention will be described.

The glass housing according to this embodiment is a housing to be used to accommodate a portable electronic device such as a cell phone, and is constituted by chemically strengthened glass obtained by chemically strengthening the above-described glass for chemical strengthening.

Chemical strengthening of the glass for chemical strengthening is carried out, for example, by dipping a glass plate in a potassium nitrate (KNO₃) molten salt heated to 400 to 550° C. for from 2 to 20 hours, but is not particularly limited to this method, and any method may be employed so long as Na₂O in the glass surface layer and K₂O in the molten salt can be ion exchanged.

By applying such chemical strengthening treatment, the surface of the chemically strengthened glass has a compressive stress layer formed. In this embodiment, the depth of the compressive stress layer is preferably at least 30 μm, more preferably at least 40 μm. If the depth is less than 30 μm, the housing may not have strength required for a housing for an electronic device such as a cell phone. However, if the compressive stress layer is too deep, the internal tensile stress tends to be great, and impact at the time of breakage tends to be great. That is, if the internal tensile stress is great, the glass tends to break into pieces and fly off when broken, thus increasing the dangerousness. As a result of experiments conducted by the present inventors, in the case of glass having a thickness of at most 2 mm, if the depth of the compressive stress layer exceeds 70 μm, flying when glass is broken tends to be remarkable. Accordingly, at least in a case where the thickness of the chemically strengthened glass is at most 2 mm, the depth of the compressive stress layer is preferably at most 70 μm, more preferably at most 60 μm, particularly preferably at most 50 μm. The surface of the chemically strengthened glass may be polished, and in such a case, the above requirements are met preferably after polishing.

The depth of the compressive stress layer means a depth in which ion exchanged alkali metal ions (potassium ions or sodium ions) are diffused into the glass, and it can be measured, for example, by a surface stress meter employing photoelastic analysis.

Further, the compressive stress layer preferably has a surface compressive stress of at least 550 MPa, more preferably at least 700 MPa. If the surface compressive stress is less than 550 MPa, the housing may not have strength required for a housing for an electronic device such as a cell phone. The surface compressive stress can be measured, for example, by a surface stress meter employing photoelasticity analysis, in the same manner as in the case of the depth of the compressive stress layer.

The chemically strengthened glass constituting the housing preferably has a thickness of at least 0.5 mm, that is, has a thickness of at least 0.5 mm at the thinnest portion, more preferably at least 0.8 mm. If the thickness of the chemically strengthened glass is less than 0.5 mm, the housing may not have strength required for a housing for an electronic device such as a cell phone, even in a case of using the chemically strengthened glass.

The present invention has been described in detail with reference to specific embodiments, however, the present invention is by no means restricted to the above description, and various changes and modifications are possible without departing from the intension and the scope of the present invention.

### Examples

Now, the present invention will be described in further detail with reference to Examples, however, the present invention is by no means restricted to such specific Examples. Examples 1-1 to 1-14, 2-1 to 2-10, 3-1 to 3-11, 4-1 to 4-11 and 5-1 and 5-2 are Examples for the glass 1 for chemical strengthening of the present invention, and Examples 1-15 and 2-9 are Comparative Examples. Examples 6-1 to 6-19 are Examples for the glass 2 for chemical strengthening of the present invention.

Commonly used glass raw materials such as oxides, hydroxides, carbonates and nitrates were properly selected so that glasses had compositions as identified in Tables 1 to 5, 8 and 9, weighed and mixed to obtain 100 ml of glass. Further, the value of SO₃ in Tables 1 to 4, 8 and 9 represents a calculated value of SO₃ remaining in glass after adding sodium sulfate (Na₂SO₄) to the glass raw materials and decomposing the sodium sulfate.

Then, the raw material mixture was put in a platinum crucible, the platinum crucible was put in a resistance heat type electric furnace at a temperature of from 1,500 to 1,600° C., and after the raw materials were melted down in about 0.5 hour, the mixture was melted for 1 hour, degassed and cast in a mold of about 50 mm×about 100 mm×about 20 mm in height preliminarily heated at about 300° C., then annealed at a rate of about 1° C./min to obtain a glass block. The glass block was cut into a size of 40 mm×40 mm×2.0 mm in thickness, and the cut glass was ground and finally both surfaces were mirror-polished to obtain plate-form glass for chemical strengthening.

Examples for the glass for chemical strengthening of the present invention shown in Table 1 are Examples for glass compositions according to the first and second embodiments of the present invention. Examples for the glass for chemical strengthening of the present invention shown in Table 2 are Examples for compositions of glasses for chemical strengthening according to the first and third embodiments of the present invention. Examples for the glass for chemical strengthening of the present invention shown in Table 3 are Examples for compositions of glasses for chemically strengthening according to the first and fourth embodiments of the present invention. Examples for the glass for chemical strengthening of the present invention shown in Table 4 are Examples for compositions of glasses for chemical strengthening according to the first and fifth embodiments of the present invention. Examples for the glass for chemical strengthening of the present invention shown in Table 5 are Examples for compositions of glasses for chemical strengthening according to the first and sixth embodiments of the present invention. Further, Examples for the glass for chemical strengthening of the present invention shown in Tables 8 and 9 are Examples for compositions of glasses for chemical strengthening according to the seventh embodiment of the present invention.

With respect to each glass for chemical strengthening obtained, the chromaticity and solarization before chemical strengthening treatment were measured. Further, with respect to the glass after chemical strengthening treatment, the depth and the surface compressive stress of the compressive stress layer formed on a surface were measured. The measuring methods and the measurement results are shown below.

### [Chromaticity]

The plate-form glass for chemical strengthening obtained in each Example was used as a measurement sample. With respect to the measurement sample, the transmittance was measured by an ultraviolet/visible/near infrared spectrophotometer (V-570 manufactured by JASCO Corporation), and the data was calculated to CIE 1931XYZ calorimetric system based on JIS Z8722:2000 (method of color measurement-reflecting and transmitting objects).

The results are shown in Tables 1 to 5. “-” in the measurement results in Tables 1 to 5, 8 and 9 represents that no measurement was carried out.

### [Solarization]

The plate-form glass for chemical strengthening obtained in each of Example 1-14 (Example of the present invention) and Example 1-15 (Comparative Example) was used as a measurement sample. The polished surface of each measurement sample was irradiated with a light from a 400 W high pressure mercury lamp from a distance of 15 cm for 50 hours, and then the average transmittance T1 at wavelengths of from 380 nm to 780 nm was measured, and the deterioration degree ΔT from the initial (before light irradiation) average transmittance T0 at wavelengths of from 380 nm to 780 nm was calculated. To measure the transmittance, an ultraviolet/visible/near infrared spectrophotometer (V-570 manufactured by JASCO Corporation) was used.

ΔT(%)=[(T0−T1)/T0]×100

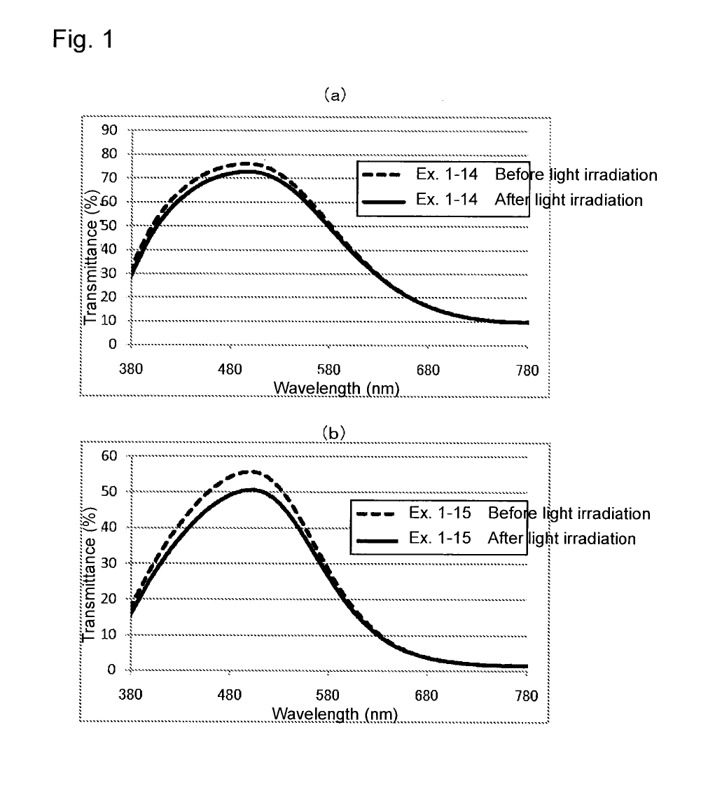

The results are shown in Table 6 together with the average transmittances T0 and T1 at wavelengths of from 380 nm to 780 nm of each sample before and after light irradiation. Further, the spectral transmittance curves of each sample measured before and after light irradiation are shown in FIG. 1. In FIG. 1, (a) represents the measurement results for Example 1-14 (Example of the present invention), and (b) represents the measurement results for Example 1-15 (Comparative Example).

It is found from Table 6 and FIG. 1 that the solarization resistance of the glass improves by the glass containing a predetermined amount of a TiO₂ component. Accordingly, when the glass for chemical strengthening of the present invention is used as a housing material, the initial colored state is maintained for a long period of time, and the design property will not be impaired by the change of color.

### [Depth and Surface Compressive Stress of Compressive Stress Layer]

The plate-form glass for chemical strengthening obtained in Example 2-1 (Example of the present invention) was dipped in a KNO₃ molten salt (100%) at 425° C. for 6 hours to carry out chemical strengthening treatment to obtain a measurement sample. Further, for comparison, the plate-form glass for chemical strengthening obtained in Example 2-9 (Comparative Example) was subjected to the same chemical strengthening treatment to obtain a measurement sample. The glass in Example 2-9 is glass having the same composition as in Example 2-1 except that the Fe₂O₃ component is not blended.

With respect to each measurement sample after chemical strengthening treatment, the depth (unit: μm) and the surface compressive stress (unit: MPa) of the compressive stress layer were measured by a surface stress meter (FSM-6000LE manufactured by Orihara Industrial Co., Ltd.). The results are shown in Table 7.

It is found from Table 7 that the strength of the glass after chemical strengthening treatment is high by the glass containing a predetermined amount of a Fe₂O₃ component. Accordingly, the glass for chemical strengthening of the present invention is suitably used as glass for a housing for an electronic device such as a cell phone, for which high strength is required.

TABLE 1

| | | Ex. | Ex. | Ex. | Ex. | Ex. | Ex. | Ex. | Ex. | Ex. | Ex. | Ex. | Ex. | Ex. |
|---|---|---|---|---|---|---|---|---|---|---|---|---|---|---|
| | | 1-1 | 1-2 | 1-3 | 1-4 | 1-5 | 1-8 | 1-9 | 1-10 | 1-11 | 1-12 | 1-13 | 1-14 | 1-15 |
| Composition | SiO₂ | 64.3 | 64.3 | 64.3 | 64.3 | 64.3 | 71.6 | 64.5 | 66.6 | 64.5 | 66.6 | 64.3 | 72.7 | 72.7 |
| (mol %) | Al₂O₃ | 8.0 | 8.0 | 8.0 | 8.0 | 8.0 | 6.0 | 6.0 | 10.8 | 6.0 | 10.8 | 8.0 | 7.0 | 7.0 |
| | Na₂O | 12.0 | 12.0 | 12.0 | 12.0 | 12.0 | 11.9 | 12.0 | 13.2 | 12.0 | 13.2 | 12.5 | 13.9 | 13.9 |
| | K₂O | 4.0 | 4.0 | 4.0 | 4.0 | 4.0 | 0.1 | 4.0 | 2.4 | 4.0 | 2.4 | 4.0 | 0.0 | 0.0 |
| | MgO | 11.0 | 11.0 | 11.0 | 11.0 | 10.5 | 10.0 | 11.0 | 6.2 | 11.0 | 6.2 | 10.5 | 6.0 | 6.0 |
| | CaO | 0.10 | 0.10 | 0.10 | 0.10 | 0.00 | 0.32 | 0.13 | 0.60 | 0.13 | 0.60 | 0.0 | 0.33 | 0.33 |
| | SrO | 0.10 | 0.10 | 0.10 | 0.10 | 0.00 | 0.06 | 0.06 | 0.0 | 0.06 | 0.0 | 0.0 | 0.06 | 0.06 |
| | BaO | 0.10 | 0.10 | 0.10 | 0.10 | 0.00 | 0.04 | 0.04 | 0.0 | 0.04 | 0.0 | 0.0 | 0.04 | 0.04 |
| | ZrO₂ | 0.49 | 0.49 | 0.49 | 0.49 | 0.49 | 0.05 | 2.50 | 0.0 | 2.50 | 0.0 | 0.49 | 0.05 | 0.05 |
| | SO₃ | 0.00 | 0.00 | 0.00 | 0.00 | 0.00 | 0.08 | 0.08 | 0.08 | 0.08 | 0.08 | 0.0 | 0.08 | 0.08 |
| | Fe₂O₃ | 0.05 | 0.05 | 0.05 | 0.05 | 0.50 | 0.10 | 0.01 | 0.01 | 0.01 | 0.05 | 0.05 | 0.03 | 0.20 |
| | TiO₂ | 1.00 | 1.00 | 0.01 | 0.01 | 0.01 | 0.05 | 0.05 | 0.02 | 1.00 | 1.00 | 0.01 | 1.0 | 0.0 |
| | CuO | 1.0 | 0.0 | 0.0 | 1.0 | 0.0 | 2.0 | 2.0 | 2.0 | 1.0 | 1.0 | 0.0 | 1.0 | 2.0 |
| | Co₃O₄ | 0.0 | 1.0 | 0.5 | 0.0 | 0.02 | 0.0 | 0.0 | 0.0 | 0.0 | 0.0 | 0.001 | 0.0 | 0.0 |
| | V₂O₅ | 0.0 | 0.0 | 0.0 | 1.0 | 0.0 | 0.0 | 0.0 | 0.0 | 0.0 | 0.0 | 0.025 | 0.0 | 0.0 |
| Chromaticity | x | 0.242 | 0.198 | 0.175 | 0.223 | 0.236 | 0.228 | 0.216 | 0.245 | 0.243 | 0.267 | 0.307 | 0.256 | 0.226 |
| coordinate | y | 0.300 | 0.052 | 0.019 | 0.253 | 0.242 | 0.322 | 0.313 | 0.329 | 0.304 | 0.321 | 0.314 | 0.308 | 0.306 |

TABLE 2

| | | Ex. | Ex. | Ex. | Ex. | Ex. | Ex. | Ex. | Ex. | Ex. | Ex. |
|---|---|---|---|---|---|---|---|---|---|---|---|
| | | 2-1 | 2-2 | 2-3 | 2-4 | 2-5 | 2-6 | 2-7 | 2-8 | 2-9 | 2-10 |
| Composition | SiO₂ | 64.3 | 64.3 | 64.3 | 61.8 | 72.7 | 71.6 | 64.5 | 61.8 | 64.3 | 64.3 |
| (mol %) | Al₂O₃ | 8.0 | 8.0 | 8.0 | 13.4 | 7.0 | 6.0 | 6.0 | 13.4 | 8.0 | 8.0 |
| | B₂O₃ | 0.0 | 0.0 | 0.0 | 6.7 | 0.0 | 0.0 | 0.0 | 2.0 | 0.0 | 0.0 |
| | Na₂O | 12.0 | 12.5 | 12.5 | 13.6 | 13.9 | 11.9 | 12.0 | 13.6 | 12.0 | 12.0 |
| | K₂O | 4.0 | 4.0 | 4.0 | 0.5 | 0.0 | 0.1 | 4.0 | 0.5 | 4.0 | 4.0 |
| | MgO | 11.0 | 10.5 | 10.5 | 0.02 | 5.97 | 9.95 | 11.0 | 4.69 | 11.0 | 11.0 |
| | CaO | 0.1 | 0.0 | 0.0 | 0.07 | 0.33 | 0.32 | 0.13 | 0.07 | 0.1 | 0.1 |
| | SrO | 0.1 | 0.0 | 0.0 | 0.0 | 0.06 | 0.06 | 0.06 | 0.0 | 0.1 | 0.1 |
| | BaO | 0.1 | 0.0 | 0.0 | 0.0 | 0.04 | 0.04 | 0.04 | 0.0 | 0.1 | 0.1 |
| | ZrO₂ | 0.5 | 0.5 | 0.5 | 0.0 | 0.05 | 0.05 | 2.50 | 0.0 | 0.5 | 0.49 |
| | SO₃ | 0.0 | 0.00 | 0.0 | 0.08 | 0.08 | 0.08 | 0.08 | 0.08 | 0.0 | 0.0 |
| | Fe₂O₃ | 1.0 | 0.5 | 0.05 | 0.05 | 0.01 | 0.10 | 0.05 | 0.10 | 0.0 | 0.05 |
| | TiO₂ | 1.0 | 0.01 | 0.5 | 1.00 | 1.00 | 1.00 | 1.00 | 0.10 | 1.0 | 0.01 |
| | V₂O₅ | 0.01 | 0.0 | 0.5 | 0.0 | 0.0 | 0.0 | 0.0 | 0.0 | 0.01 | 0.0 |
| | CuO | 0.0 | 1.0 | 0.5 | 1.0 | 0.0 | 0.0 | 0.0 | 2.0 | 0.0 | 0.048 |
| | Cr₂O₃ | 0.0 | 0.0 | 0.0 | 0.0 | 0.2 | 0.2 | 0.2 | 0.0 | 0.0 | 0.0 |
| Chromaticity | x | 0.353 | 0.343 | 0.351 | 0.337 | 0.398 | 0.397 | 0.398 | 0.291 | — | 0.307 |
| coordinate | y | 0.383 | 0.400 | 0.401 | 0.393 | 0.517 | 0.519 | 0.529 | 0.395 | — | 0.316 |

TABLE 3

| | | Ex. | Ex. | Ex. | Ex. | Ex. | Ex. | Ex. | Ex. | Ex. | Ex. | Ex. |
|---|---|---|---|---|---|---|---|---|---|---|---|---|
| | | 3-1 | 3-2 | 3-3 | 3-4 | 3-5 | 3-6 | 3-7 | 3-8 | 3-9 | 3-10 | 3-11 |
| Composition | SiO₂ | 64.3 | 64.3 | 64.3 | 64.3 | 64.5 | 66.6 | 64.5 | 61.8 | 72.7 | 64.5 | 64.3 |
| (mol %) | Al₂O₃ | 8.0 | 8.0 | 8.0 | 8.0 | 6.0 | 10.8 | 6.0 | 13.4 | 7.0 | 6.0 | 8.0 |
| | B₂O₃ | 0.0 | 0.0 | 0.0 | 0.0 | 0.0 | 0.0 | 0.0 | 6.7 | 0.0 | 0.0 | 0.0 |
| | Na₂O | 12.0 | 12.0 | 12.5 | 12.5 | 12.0 | 13.2 | 12.0 | 13.6 | 13.9 | 12.0 | 12.0 |
| | K₂O | 4.0 | 4.0 | 4.0 | 4.0 | 4.0 | 2.4 | 4.0 | 0.5 | 0.0 | 4.0 | 4.0 |
| | MgO | 11.0 | 11.0 | 10.5 | 10.5 | 11.0 | 6.20 | 11.0 | 0.02 | 5.97 | 11.0 | 11.0 |
| | CaO | 0.1 | 0.1 | 0.0 | 0.0 | 0.13 | 0.60 | 0.13 | 0.07 | 0.33 | 0.13 | 0.1 |
| | SrO | 0.1 | 0.1 | 0.0 | 0.0 | 0.06 | 0.00 | 0.06 | 0.00 | 0.06 | 0.06 | 0.1 |
| | BaO | 0.1 | 0.1 | 0.0 | 0.0 | 0.04 | 0.00 | 0.04 | 0.00 | 0.04 | 0.04 | 0.1 |
| | ZrO₂ | 0.5 | 0.5 | 0.5 | 0.5 | 2.50 | 0.00 | 2.50 | 0.00 | 0.05 | 2.50 | 0.5 |
| | SO₃ | 0.0 | 0.0 | 0.0 | 0.0 | 0.08 | 0.08 | 0.08 | 0.08 | 0.08 | 0.08 | 0.0 |
| | Fe₂O₃ | 0.05 | 0.05 | 0.05 | 0.05 | 0.10 | 0.01 | 0.05 | 0.50 | 0.10 | 0.01 | 0.05 |
| | TiO₂ | 0.01 | 2.0 | 1.0 | 1.0 | 0.20 | 0.10 | 0.20 | 0.10 | 1.00 | 1.00 | 0.01 |
| | CeO₂ | 1.0 | 2.0 | 0.0 | 0.0 | 0.0 | 0.0 | 1.0 | 1.0 | 0.0 | 0.0 | 0.0 |
| | V₂O₅ | 1.0 | 0.0 | 1.0 | 2.0 | 2.0 | 2.0 | 1.0 | 1.0 | 1.0 | 1.0 | 0.03 |
| | CuO | 0.0 | 0.0 | 1.0 | 0.0 | 0.0 | 0.0 | 0.0 | 0.0 | 0.0 | 0.0 | 0.0 |
| Chromaticity | x | 0.431 | 0.401 | 0.470 | 0.456 | 0.447 | 0.500 | 0.431 | 0.603 | 0.380 | 0.354 | 0.312 |
| coordinate | y | 0.445 | 0.410 | 0.491 | 0.439 | 0.434 | 0.439 | 0.444 | 0.394 | 0.400 | 0.371 | 0.319 |

TABLE 4

| | | Ex. | Ex. | Ex. | Ex. | Ex. | Ex. | Ex. | Ex. | Ex. | Ex. | Ex. |
|---|---|---|---|---|---|---|---|---|---|---|---|---|
| | | 4-1 | 4-2 | 4-3 | 4-4 | 4-5 | 4-6 | 4-7 | 4-8 | 4-9 | 4-10 | 4-11 |
| Composition | SiO₂ | 64.3 | 64.3 | 72.7 | 71.6 | 64.5 | 66.6 | 61.8 | 72.7 | 71.6 | 64.5 | 66.6 |
| (mol %) | Al₂O₃ | 8.0 | 8.0 | 7.0 | 6.0 | 6.0 | 10.8 | 13.4 | 7.0 | 6.0 | 6.0 | 10.8 |
| | B₂O₃ | 0.0 | 0.0 | 0.0 | 0.0 | 0.0 | 0.0 | 6.7 | 0.0 | 0.0 | 0.0 | 0.0 |
| | Na₂O | 12.0 | 12.0 | 13.9 | 11.9 | 12.0 | 13.2 | 13.6 | 13.9 | 11.9 | 12.0 | 13.2 |
| | K₂O | 4.0 | 4.0 | 0.0 | 0.1 | 4.0 | 2.4 | 0.5 | 0.0 | 0.1 | 4.0 | 2.4 |
| | MgO | 10.97 | 10.97 | 5.97 | 9.95 | 11.00 | 6.20 | 0.02 | 5.97 | 9.95 | 11.00 | 6.20 |
| | CaO | 0.10 | 0.10 | 0.33 | 0.32 | 0.13 | 0.60 | 0.07 | 0.33 | 0.32 | 0.13 | 0.60 |
| | SrO | 0.10 | 0.10 | 0.06 | 0.06 | 0.06 | 0.00 | 0.00 | 0.06 | 0.06 | 0.06 | 0.00 |
| | BaO | 0.10 | 0.10 | 0.04 | 0.04 | 0.04 | 0.00 | 0.00 | 0.04 | 0.04 | 0.04 | 0.00 |
| | ZrO₂ | 0.49 | 0.49 | 0.05 | 0.05 | 2.50 | 0.00 | 0.00 | 0.05 | 0.05 | 2.50 | 0.00 |
| | SO₃ | 0.00 | 0.00 | 0.08 | 0.08 | 0.08 | 0.08 | 0.08 | 0.08 | 0.08 | 0.08 | 0.08 |
| | Fe₂O₃ | 0.05 | 0.05 | 0.01 | 0.02 | 0.01 | 0.05 | 0.10 | 0.05 | 0.03 | 0.01 | 0.20 |
| | TiO₂ | 0.01 | 0.01 | 1.00 | 1.00 | 1.00 | 1.00 | 1.00 | 0.10 | 0.05 | 0.30 | 0.50 |
| | MnO₂ | 1.5 | 1.0 | 1.0 | 1.0 | 1.0 | 1.0 | 1.0 | 0.0 | 0.0 | 0.0 | 0.0 |
| | Er₂O₃ | 0.0 | 0.0 | 0.0 | 0.0 | 0.0 | 0.0 | 0.0 | 0.1 | 0.1 | 0.1 | 0.1 |
| Chromaticity | x | 0.425 | 0.383 | 0.355 | 0.351 | 0.373 | 0.363 | 0.353 | 0.311 | 0.317 | 0.312 | 0.312 |
| coordinate | y | 0.305 | 0.308 | 0.312 | 0.322 | 0.312 | 0.320 | 0.337 | 0.315 | 0.314 | 0.315 | 0.314 |

TABLE 5

| | | Ex. 5-1 | Ex. 5-2 |
|---|---|---|---|
| Composition | SiO₂ | 64.3 | 64.3 |
| (mol %) | Al₂O₃ | 8.0 | 8.0 |
| | B₂O₃ | 0.0 | 0.0 |
| | Na₂O | 12.0 | 12.5 |
| | K₂O | 4.0 | 4.0 |
| | MgO | 11.0 | 10.5 |
| | CaO | 0.1 | 0.0 |
| | SrO | 0.1 | 0.0 |
| | BaO | 0.1 | 0.0 |
| | ZrO₂ | 0.5 | 0.5 |
| | Fe₂O₃ | 0.05 | 0.05 |
| | TiO₂ | 0.01 | 0.01 |
| | Cu₂O | 0.30 | 0.35 |
| | SnO | 0.40 | 0.60 |
| Chromaticity | x | 0.504 | 0.424 |
| coordinate | y | 0.347 | 0.328 |

TABLE 6

| | Average transmittance (%) | | |
|---|---|---|---|
| | Before light | After light | Deterioration |
| | irradiation (T0) | irradiation (T1) | degree (%) |
| Ex. 1-14 (Example) | 43.17 | 41.48 | 3.9 |
| Ex. 1-15 (Comparative | 25.32 | 23.24 | 8.2 |
| Example) | | | |

TABLE 7

| | Compressive stress layer | |
|---|---|---|
| | Depth (μm) | Surface compressive stress (MPa) |
| Ex. 2-1 (Example) | 41.3 | 924 |
| Ex. 2-9 (Comparative | 37.0 | 900 |
| Example) | | |

TABLE 8

| | | Ex. | Ex. | Ex. | Ex. | Ex. | Ex. | Ex. | Ex. | Ex. | Ex. |
|---|---|---|---|---|---|---|---|---|---|---|---|
| | | 6-1 | 6-2 | 6-3 | 6-4 | 6-5 | 6-6 | 6-7 | 6-8 | 6-9 | 6-10 |
| Composition | SiO₂ | 68.2 | 68.1 | 67.4 | 66.9 | 67.8 | 67.9 | 67.6 | 69.1 | 67.8 | 67.2 |
| (mol %) | Al₂O₃ | 1.0 | 1.0 | 1.0 | 1.0 | 1.0 | 0.9 | 1.0 | 1.1 | 1.0 | 1.1 |
| | B₂O₃ | 2.2 | 2.0 | 2.2 | 1.9 | 2.3 | 2.4 | 2.3 | 2.0 | 4.4 | 2.2 |
| | Na₂O | 12.0 | 12.6 | 12.3 | 12.0 | 12.4 | 13.2 | 11.9 | 12.5 | 10.9 | 12.5 |
| | K₂O | 3.1 | 3.0 | 3.0 | 3.0 | 3.0 | 1.8 | 3.0 | 3.2 | 3.1 | 3.0 |
| | MgO | 5.9 | 5.5 | 6.5 | 6.8 | 6.2 | 5.8 | 5.9 | 5.3 | 4.6 | 6.4 |
| | CaO | 6.8 | 6.5 | 6.9 | 7.2 | 6.9 | 6.7 | 6.7 | 6.2 | 6.1 | 7.0 |
| | SrO | 0.0 | 0.0 | 0.0 | 0.0 | 0.0 | 0.0 | 0.0 | 0.0 | 0.0 | 0.0 |
| | BaO | 0.04 | 0.03 | 0.0 | 0.0 | 0.03 | 0.02 | 0.0 | 0.0 | 0.0 | 0.0 |
| | ZnO | 0.1 | 0.1 | 0.0 | 0.0 | 0.0 | 0.0 | 0.04 | 0.1 | 0.0 | 0.0 |
| | P₂O₅ | 0.0 | 0.0 | 0.0 | 0.0 | 0.0 | 0.0 | 0.0 | 0.0 | 0.0 | 0.0 |
| | PbO | 0.0 | 0.0 | 0.0 | 0.0 | 0.0 | 0.0 | 0.0 | 0.0 | 0.0 | 0.01 |
| | F | 0.0 | 0.0 | 0.0 | 0.0 | 0.0 | 0.0 | 0.64 | 0.0 | 0.0 | 0.19 |
| | Cl | 0.02 | 0.02 | 0.02 | 0.03 | 0.03 | 0.03 | 0.02 | 0.02 | 0.0 | 0.03 |
| | SO₃ | 0.23 | 0.23 | 0.30 | 0.30 | 0.15 | 0.23 | 0.15 | 0.15 | 0.23 | 0.30 |
| | Fe₂O₃ | 0.114 | 0.693 | 0.015 | 0.019 | 0.038 | 0.023 | 0.019 | 0.031 | 0.023 | 0.019 |
| | TiO₂ | 0.053 | 0.077 | 0.046 | 0.061 | 0.076 | 0.053 | 0.076 | 0.061 | 0.039 | 0.053 |
| | Cr₂O₃ | 0.02 | 0.0 | 0.00 | 0.01 | 0.0 | 0.0 | 0.0 | 0.0 | 0.04 | 0.04 |
| | MnO | 0.0 | 0.01 | 0.34 | 0.77 | 0.0 | 0.0 | 0.0 | 0.0 | 0.0 | 0.0 |
| | Co₂O₃ | 0.02 | 0.02 | 0.01 | 0.04 | 0.02 | 0.0 | 0.08 | 0.24 | 0.03 | 0.0 |
| | NiO | 0.08 | 0.16 | 0.0 | 0.0 | 0.0 | 0.0 | 0.0 | 0.0 | 0.0 | 0.0 |
| | CuO | 0.0 | 0.0 | 0.0 | 0.0 | 0.0 | 0.83 | 0.46 | 0.0 | 1.70 | 0.0 |
| | Rb₂O | 0.0 | 0.0 | 0.0 | 0.0 | 0.0 | 0.0 | 0.0 | 0.0 | 0.0 | 0.0 |
| | SnO₂ | 0.0 | 0.0 | 0.0 | 0.0 | 0.0 | 0.0 | 0.004 | 0.012 | 0.0 | 0.0 |
| | CeO₂ | 0.0 | 0.0 | 0.0 | 0.0 | 0.0 | 0.0 | 0.04 | 0.0 | 0.0 | 0.0 |
| Chromaticity | x | 0.311 | 0.301 | 0.300 | 0.279 | 0.285 | 0.250 | 0.184 | 0.156 | 0.181 | 0.320 |
| coordinate | y | 0.325 | 0.322 | 0.292 | 0.239 | 0.292 | 0.290 | 0.153 | 0.042 | 0.214 | 0.358 |

TABLE 9

| | | Ex. | Ex. | Ex. | Ex. | Ex. | Ex. | Ex. | Ex. | Ex. |
|---|---|---|---|---|---|---|---|---|---|---|
| | | 6-11 | 6-12 | 6-13 | 6-14 | 6-15 | 6-16 | 6-17 | 6-18 | 6-19 |
| Composition | SiO₂ | 67.5 | 68.0 | 67.5 | 68.1 | 71.7 | 67.5 | 68.0 | 70.7 | 70.6 |
| (mol %) | Al₂O₃ | 1.0 | 1.0 | 1.0 | 1.1 | 0.1 | 1.0 | 1.1 | 1.1 | 1.4 |
| | B₂O₃ | 2.4 | 2.6 | 2.7 | 2.5 | 2.8 | 2.1 | 2.1 | 0.0 | 0.0 |
| | Na₂O | 12.5 | 12.8 | 12.4 | 12.3 | 11.5 | 12.4 | 12.4 | 12.4 | 12.4 |
| | K₂O | 3.0 | 2.9 | 2.9 | 3.0 | 4.1 | 2.9 | 3.0 | 0.2 | 0.2 |
| | MgO | 6.5 | 5.6 | 5.9 | 6.1 | 0.0 | 6.3 | 5.9 | 5.4 | 5.4 |
| | CaO | 6.6 | 6.4 | 6.4 | 6.5 | 2.5 | 6.9 | 6.3 | 8.5 | 8.1 |
| | SrO | 0.0 | 0.0 | 0.0 | 0.0 | 0.0 | 0.0 | 0.0 | 0.0 | 0.0 |
| | BaO | 0.0 | 0.0 | 0.03 | 0.02 | 1.61 | 0.0 | 0.0 | 0.0 | 0.0 |
| | ZnO | 0.0 | 0.0 | 0.0 | 0.0 | 4.6 | 0.0 | 0.0 | 0.0 | 0.0 |
| | P₂O₅ | 0.0 | 0.0 | 0.0 | 0.0 | 0.02 | 0.0 | 0.0 | 0.0 | 0.0 |
| | PbO | 0.0 | 0.0 | 0.0 | 0.0 | 0.0 | 0.0 | 0.0 | 0.0 | 0.0 |
| | F | 0.0 | 0.0 | 0.0 | 0.0 | 0.0 | 0.13 | 0.0 | 0.0 | 0.0 |
| | Cl | 0.03 | 0.03 | 0.05 | 0.02 | 0.37 | 0.03 | 0.02 | 0.0 | 0.0 |
| | SO₃ | 0.23 | 0.23 | 0.30 | 0.15 | 0.01 | 0.38 | 0.30 | 0.10 | 0.10 |
| | Fe₂O₃ | 0.019 | 0.015 | 0.019 | 0.267 | 0.008 | 0.019 | 0.023 | 0.005 | 0.008 |
| | TiO₂ | 0.152 | 0.053 | 0.046 | 0.053 | 0.002 | 0.053 | 0.046 | 0.002 | 0.001 |
| | Cr₂O₃ | 0.08 | 0.16 | 0.20 | 0.0 | 0.0 | 0.01 | 0.02 | 0.0 | 0.0 |
| | MnO | 0.0 | 0.0 | 0.09 | 0.0 | 0.0 | 0.26 | 0.94 | 0.0 | 0.0 |
| | Co₂O₃ | 0.01 | 0.0 | 0.0 | 0.0 | 0.0 | 0.0 | 0.0 | 0.05 | 0.05 |
| | NiO | 0.02 | 0.04 | 0.0 | 0.02 | 0.0 | 0.0 | 0.0 | 0.65 | 0.80 |
| | CuO | 0.0 | 0.15 | 0.38 | 0.0 | 0.16 | 0.0 | 0.0 | 0.98 | 0.98 |
| | Rb₂O | 0.0 | 0.0 | 0.0 | 0.0 | 0.003 | 0.0 | 0.0 | 0.0 | 0.0 |
| | SnO₂ | 0.0 | 0.0 | 0.0 | 0.0 | 0.516 | 0.0 | 0.0 | 0.0 | 0.0 |
| | CeO₂ | 0.0 | 0.0 | 0.0 | 0.0 | 0.0 | 0.0 | 0.0 | 0.0 | 0.0 |
| Chromaticity | x | 0.323 | 0.327 | 0.268 | 0.341 | 0.695 | 0.332 | 0.386 | — | — |
| coordinate | y | 0.381 | 0.483 | 0.455 | 0.339 | 0.304 | 0.311 | 0.281 | — | — |

### INDUSTRIAL APPLICABILITY

The glass for chemical strengthening of the present invention is suitably used as a material of a housing to accommodate a portable communication device or information device such as a cell phone. In addition, it is also applicable to operation panels for audio visual equipment/office automation equipment, doors and operation buttons for such equipment, or decorative articles such as decorative panels arranged around a rectangular display surface of image display panels such as digital photo frames or TVs.

This application is a continuation of PCT Application No. PCT/JP2012/070014, filed on Aug. 6, 2012, which is based upon and claims the benefit of priority from Japanese Patent Application No. 2011-175421 filed on Aug. 10, 2011 and Japanese Patent Application No. 2011-178526 filed on Aug. 17, 2011. The contents of those applications are incorporated herein by reference in its entirety.

What is claimed is:

1. Glass for chemical strengthening, which comprises, as represented by mole percentage based on oxides, at least from 55 to 80% of SiO₂, from 5 to 20% of Na₂O, from 0.001 to 3% of Fe₂O₃ and from 0.001 to 3% of TiO₂, and contains as a coloring component from 0.001 to 10% of MpOq (wherein M is at least one member selected from Co, Cu, V, Cr, Pr, Ce, Bi, Eu, Mn, Er, Ni, Nd, W, Rb, Sn and Ag, and p and q represent the atomic ratio of M and O).

2. The glass for chemical strengthening according to claim 1, which comprises, as represented by mole percentage based on oxides, from 55 to 80% of SiO₂, from 3 to 16% of Al₂O₃, from 0 to 12% of B₂O₃, from 5 to 16% of Na₂O, from 0 to 5% of K₂O, from 0 to 15% of MgO, from 0 to 5% of ZnO, from 0 to 1% of RO (wherein R is at least one member selected from Sr, Ba and Ca), from 0 to 5% of ZrO₂, from 0.001 to 3% of Fe₂O₃ and from 0.001 to 3% of TiO₂, and further contains as a coloring component from 0.001 to 10% of MpOq (wherein M is at least one member selected from Co, Cu, V, Cr, Pr, Ce, Bi, Eu, Mn, Er, Ni, Nd, W, Rb, Sn and Ag, and p and q represent the atomic ratio of M and O).

3. The glass for chemical strengthening according to claim 1, which comprises, as represented by mole percentage based on oxides, from 55 to 80% of SiO₂, from 3 to 16% of Al₂O₃, from 0 to 12% of B₂O₃, from 5 to 16% of Na₂O, from 0 to 15% of K₂O, from 0 to 15% of MgO, from 0 to 5% of ZnO, from 0 to 1% of RO (wherein R is at least one member selected from Sr, Ba and Ca), from 0 to 5% of ZrO₂, from 0.001 to 3% of Fe₂O₃ and from 0.001 to 3% of TiO₂, and further contains as a coloring component from 0.001 to 10% of MpOq (wherein M is at least one member selected from Co, Cu, V, Cr, Pr, Ce, Bi, Eu, Mn, Er, Ni, Nd, W, Rb, Sn and Ag, and p and q represent the atomic ratio of M and O).

4. The glass for chemical strengthening according to claim 1, which comprises, as represented by mole percentage based on oxides, from 55 to 80% of SiO₂, from 0 to 5% of Al₂O₃, from 0 to 12% of B₂O₃, from 5 to 20% of Na₂O, from 0 to 8% of K₂O, from 1 to 15% of CaO, from 0 to 5% of ZnO, from 0 to 10% of RO (wherein R is at least one member selected from Sr, Ba and Mg), from 0 to 5% of ZrO₂, from 0.001 to 3% of Fe₂O₃ and from 0.001 to 3% of TiO₂, and further contains as a coloring component from 0.001 to 10% of MpOq (wherein M is at least one member selected from Co, Cu, V, Cr, Pr, Ce, Bi, Eu, Mn, Er, Ni, Nd, W, Rb, Sn and Ag, and p and q represent the atomic ratio of M and O).

5. The glass for chemical strengthening according to claim 1, which contains, as the coloring component, from 0 to 3% of Co₃O₄ and from 0 to 8% of CuO in a total content of from 0.01 to 8%.

6. The glass for chemical strengthening according to claim 5, wherein the transmission color tone measured by using illuminant C in a thickness of 2 mm, as represented by the value (x,y) on the CIE chromaticity coordinate, satisfy the following conditions:
0.00≦x≦0.32
0.00≦y≦0.40

7. The glass for chemical strengthening according to claim 1, which contains as the coloring component from 0 to 5% of V₂O₅, from 0 to 5% of Cr₂O₃, from 0 to 8% of CuO and from 0 to 3% of Pr₆O₁₁ in a total content of from 0.01 to 8%.

8. The glass for chemical strengthening according to claim 7, wherein the transmission color tone measured by using illuminant C in a thickness of 2 mm, as represented by the value (x,y) on the CIE chromaticity coordinate, satisfy the following conditions:
0.00≦x≦0.42
0.31≦y≦0.78

9. The glass for chemical strengthening according to claim 1, which contains as the coloring component from 0 to 3% of CeO₂, from 0 to 5% of V₂O₅, from 0 to 10% of Bi₂O₃ and from 0 to 3% of Eu₂O₃ in a total content of from 0.01 to 10%.

10. The glass for chemical strengthening according to claim 9, wherein the transmission color tone measured by using illuminant C in a thickness of 2 mm, as represented by the value (x,y) on the CIE chromaticity coordinate, satisfy the following conditions:
0.31≦x≦0.66
0.31≦y≦0.58

11. The glass for chemical strengthening according to claim 1, which contains as the coloring component from 0 to 10% of MnO₂, from 0 to 3% of Er₂O₃, from 0 to 5% of NiO, from 0 to 3% of Nd₂O₃ and from 0 to 10% of WO₃ in a total content of from 0.01 to 10%.

12. The glass for chemical strengthening according to claim 11, wherein the transmission color tone measured by using illuminant C in a thickness of 2 mm, as represented by the value (x,y) on the CIE chromaticity coordinate, satisfy the following conditions:
0.26≦x≦0.50
0.04≦y≦0.34

13. The glass for chemical strengthening according to claim 1, which further contains from 0 to 3% of SnO and from 0 to 5% of Sb₂O₃ and contains as the coloring component from 0 to 3% of Cu₂O and from 0 to 6% of Ag₂O, in a total content of SnO and Sb₂O₃ of from 0.01 to 5% and in a total content of Cu₂O and Ag₂O of from 0.001 to 6%.

14. The glass for chemical strengthening according to claim 13, wherein the transmission color tone measured by using illuminant C in a thickness of 2 mm, as represented by the value (x,y) on the CIE chromaticity coordinate, satisfy the following conditions:
0.31≦x≦0.73
0.20≦y≦0.35

15. The glass for chemical strengthening according to claim 1, wherein the transmittance deterioration degree ΔT as obtained by the following formula is at most 5%:
ΔT(%)=[(T0−T1)/T0]×100
wherein T1 is the average transmittance at wavelengths of from 380 nm to 780 nm in a spectral transmittance curve obtained after a polished surface of glass having a thickness of 2 mm having both surfaces optically mirror-polished, is irradiated with light of a 400 W high pressure mercury lamp with a distance of 15 cm for 50 hours, and T0 is the average transmittance at wavelengths of from 380 nm to 780 nm in a spectral transmittance curve before light irradiation.

16. The glass for chemical strengthening according to claim 1, which is glass to be used for forming chemically strengthened glass having a compressive stress layer having a thickness of at least 30 μm and a surface compressive stress of at least 550 MPa formed on the glass surface by chemical strengthening treatment.

17. A glass housing comprising chemically strengthened glass obtained by subjecting the glass for chemical strengthening as defined in claim 1 to chemical strengthening treatment.

18. The glass housing according to claim 17, wherein the chemically strengthened glass has a thickness of at least 0.5 mm.

19. The glass housing according to claim 17, wherein the chemically strengthened glass has a compressive stress layer having a depth of at least 30 μm and a surface compressive stress of at least 550 MPa formed on its surface by the chemical strengthening treatment.

20. The glass house according to claim 17, which is a glass housing to be used to accommodate an electronic device.
